(19) United States
(12) Patent Application Publication
(10) Pub. No.: US 2015/0201013 A1
(43) Pub. Date: Jul. 16, 2015

(54) INFORMATION PROCESSING APPARATUS, DATA COPY PROCESSING MANAGEMENT METHOD, AND NON-TRANSITORY COMPUTER-READABLE RECORDING MEDIUM HAVING STORED THEREIN DATA COPY PROCESSING MANAGEMENT PROGRAM

(71) Applicant: FUJITSU LIMITED, Kawasaki-shi (JP)

(72) Inventor: Takashi Nonaka, Yokohama (JP)

(21) Appl. No.: 14/589,221

(22) Filed: Jan. 5, 2015

(30) Foreign Application Priority Data
Jan. 14, 2014 (JP) 2014-004062

(51) Int. Cl. H04L 29/08; G06F 3/06

(52) U.S. Cl. CPC H04L 67/1095; G06F 3/0619; G06F 3/0647; G06F 3/0689

(57) ABSTRACT

An information processing apparatus includes an overlap degree estimation information creating unit that create overlap degree estimation information indicating an estimated overlap degree of tasks which are executed in the storage apparatus by the information processing apparatus and the other information processing apparatus, an influence degree estimation information creating unit that create influence degree estimation information indicating an influence degree on a performance of the storage apparatus in which an overlapping of the tasks is estimated to occur, and a completion estimation time calculating unit that calculate a data copy completion estimation time based on the overlap degree estimation information and the influence degree estimation information.

### CROSS-REFERENCE TO RELATED APPLICATION

This application is based upon and claims the benefit of priority of the prior Japanese Patent application No. 2014-004062, filed on Jan. 14, 2014, the entire contents of which are incorporated herein by reference.

### FIELD

The embodiments discussed herein are directed to an information processing apparatus, a data copy processing management method, and a non-transitory computer-readable recording medium having stored therein data copy processing management program.

### BACKGROUND

In recent year, there is known a storage system in which the amount of data handled in business processes increases and accordingly the amount of data increases in a copy process as a backup/system configuration is changed, so that a copy time estimation process is performed as a business plan.

FIG. 33 is a diagram illustrating a copy time estimation process in a storage system as a related art.

A storage system 100a illustrated in FIG. 33 includes two server apparatuses 1a, two switches 4a, and three storage apparatuses 2a. Then, the server apparatus 1a accesses any one (the storage apparatus 2a) of three storage apparatuses 2a through any one (the switch 4a) of two switches 4a.

Hereinafter, when it is necessary to specify one of a plurality of server apparatuses, the server apparatus will be simply denoted by a “server apparatus #1” or a “server apparatus #2”, and when an arbitrary server apparatus is indicated, it will be denoted by the “server apparatus 1a”. Further, hereinafter, when it is necessary to specify one of a plurality of switches, the switch is simply denoted by a “switch #1” or a “switch #2”, and when an arbitrary switch is indicated, it will be denoted by the “switch 4a”. Furthermore, hereinafter, when it is necessary to specify one of a plurality of storage apparatuses, the storage apparatus will be simply denoted by a “storage apparatus #1”, a “storage apparatus #2”, or a “storage apparatus #3”, and when an arbitrary storage apparatus is indicated, it will be denoted by the “storage apparatus 2a”.

The server apparatus 1a develops a hypervisor 110a. Specifically, the server apparatuses #1 and #2 develops hypervisors #1 and #2, respectively.

Hereinafter, when it is necessary to specify one of a plurality of hypervisors, the hypervisor will be simply denoted by the “hypervisor #1” or the “hypervisor #2”, and when an arbitrary hypervisor is indicated, it will be denoted by the “hypervisor 110a”.

Furthermore, the server apparatus 1a develops two virtual servers 111a on the developed hypervisor 110a. Specifically, the server apparatus #1 develops virtual servers #1 and #2 on the developed hypervisor #1, and the server apparatus #2 develops virtual servers #3 and #4 on the developed hypervisor #2.

Hereinafter, when it is necessary to specify one of a plurality of virtual servers, the virtual server will be simply denoted by the “virtual server #1”, the “virtual server #2”, the “virtual server #3”, or the “virtual server #4”, and when an arbitrary virtual server is indicated, it will be denoted by the “virtual server 111a”.

Then, the virtual server 111a executes a business application 21a, and executes an input/output (I/O) process such as a data copy process (a backup process) on the storage apparatus 2a through the business application 21a.

Four users 5a illustrated in FIG. 33 instruct the virtual server 111a to execute the data copy process to the storage apparatus 2a and the I/O process such as the copy time estimation process. Specifically, users #1 to #4 instruct the virtual servers #1 to #4 to execute the data copy process to the storage apparatus 2a and the I/O process such as the copy time estimation process, respectively.

Hereinafter, when it is necessary to specify one of a plurality of users, the user will be simply denoted by the “user #1”, the “user #2”, the “user #3”, or the “user #4”, and when an arbitrary user is indicated, it will be denoted by the “user 5a”.

In the example illustrated in FIG. 33, the user #1 wonders whether a data copy process performed onto the storage apparatus #1 from at 11:00 p.m. could be completed before 6:00 a.m. tomorrow. Therefore, the user #1 instructs the virtual server #1 to perform the copy time estimation process (see Reference numeral H1).

The business application 21a of the virtual server #1 measures a data copy speed, and estimates a completion time of the data copy process. The business application 21a of the virtual server #1 writes some pieces of data relating to the data copy process in the storage apparatus #1 to measure the data copy speed (see Reference numeral H2). Then, the business application 21a of the virtual server #1 estimates the completion time of the data copy process based on the measured data copy speed and the number of files and blocks relating to the data copy process. Herein, the business application 21a of the virtual server #1 estimates that the data copy process performed onto the storage apparatus #1 starts from 11:00 p.m. and completed at 5:00 a.m. tomorrow.

As described above, there is known a storage system which performs the copy time estimation process to measure the data copy speed by writing some pieces of data relating to the data copy process in the target storage apparatus.

[Patent Literature 1] Japanese Laid-open Patent Publication No. 2012-83870

[Patent Literature 2] Japanese Laid-open Patent Publication No. 2008-293233

[Patent Literature 3] Japanese Laid-open Patent Publication No. 2010-266993

However, in the storage system 100a of the related art, as tasks performed by the server apparatus 1a onto the storage apparatus 2a are increased in number and the server apparatuses 1a and the storage apparatuses 2a are increased in number, estimation of the copy time becomes difficult. Specifically, tasks waiting for the process may be registered in the storage apparatus 2a as the functional level of the storage apparatus 2a is heightened, so that a load on the storage apparatus 2a is increased. Then, there is a possibility to unexpectedly reduce the copy speed due to the business application 21a of the server apparatus 1a. Further, in a case where a plurality of server apparatuses 1a issue tasks to one storage apparatus 2a, it is difficult for the business application 21a of the server apparatus 1a to estimate performance deterioration of the storage apparatus 2a which is caused by the task issued by another server apparatus 1a. Furthermore, as the number of tasks issued by the respective server apparatuses 1a is increased, a time relation in the process of the tasks in the storage apparatus 2a is also complicated.

FIG. 34 is a diagram illustrating a data copy process in the storage system as a related art.

Hereinafter, in FIG. 34, since the same reference numerals as those described already indicate the similar components to those described above, the descriptions thereof will not be repeated.

In the example illustrated in FIG. 33, a completion time of the data copy process estimated by the business application 21a of the virtual server #1 is 5:00 a.m. tomorrow which satisfies a condition of 6:00 a.m. tomorrow desired by the user #1. Then, the user #1 instructs the virtual server #1 to execute the data copy process on the storage apparatus #1 (see Reference numeral I1). The business application 21a of the virtual server #1 writes target data in the storage apparatus #1 to start the data copy process (see Reference numeral I2).

In the example illustrated in FIG. 34, the user #3 instructs the virtual server #3 to execute the data copy process to the storage apparatus #1 in the same time zone as that of the data copy process performed by the virtual server #1 (see Reference numeral I3). The business application 21a of the virtual server #3 writes target data in the storage apparatus #1 to start the data copy process (see Reference numeral I4).

Similarly, the user #4 instructs the virtual server #4 to execute the data copy process to the storage apparatuses #1 and #3 in the same time zone as that of the data copy process performed by the virtual server #1 (see Reference numeral I5). The business application 21a of the virtual server #4 writes target data in the storage apparatuses #1 and #3 to start the data copy process (see Reference numerals I6 and I7).

Herein, as denoted by Reference numerals I2, I4, and I6, the I/O processes and the execution of the tasks relating to the data copy processes caused by the virtual servers #1, #3, and #4 are concentrated on the storage apparatus #1. Therefore, the data copy speed during the data copy process on the storage apparatus #1 is lower than the data copy speed measured by the business application 21a of the virtual server #1 in the copy time estimation process. Then, the completion time of the data copy process by the virtual server #1 is delayed behind 5:00 a.m. tomorrow which is the completion time estimated by the business application 21a of the virtual server #1 in the copy time estimation process.

As described above, the server apparatus (the virtual server) of a rerated art has a problem in that the completion time of the data copy process is not accurately estimated because of an influence due to the I/O process and the execution of the tasks performed by another server apparatus (the virtual server) which shares the storage apparatus.

### SUMMARY

According to an aspect of the invention, there is provided an information processing apparatus which shares a storage apparatus with another information processing apparatus. The information processing apparatus includes an overlap degree estimation information creating unit configured to create overlap degree estimation information indicating an estimated overlap degree of tasks which are executed in the storage apparatus by the information processing apparatus and the other information processing apparatus, an influence degree estimation information creating unit configured to create influence degree estimation information indicating an influence degree on a performance of the storage apparatus in which an overlapping of the tasks is estimated to occur, and a completion estimation time calculating unit configured to calculate a data copy completion estimation time based on the overlap degree estimation information and the influence degree estimation information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating functional configurations of a storage system as an exemplary embodiment;

FIG. 2 is a diagram schematically illustrating functional configurations of a server apparatus in the storage system as the exemplary embodiment;

FIG. 3 is a diagram schematically illustrating an exemplary operation in the storage system as the exemplary embodiment;

FIG. 4 is a diagram illustrating a plan table in the storage system as the exemplary embodiment;

FIG. 5 is a diagram illustrating a plan LUN table in the storage system as the exemplary embodiment;

FIG. 6 is a diagram illustrating a task table in the storage system as the exemplary embodiment;

FIG. 7 is a diagram illustrating a RAID group table in the storage system as the exemplary embodiment;

FIG. 8 is a diagram illustrating a plan/task total table in the storage system as the exemplary embodiment;

FIG. 9 is a diagram illustrating an overlap degree table in the storage system as the exemplary embodiment;

FIG. 10 is a diagram illustrating an influence degree table in the storage system as the exemplary embodiment;

FIG. 11 is a diagram illustrating an estimation time table in the storage system as the exemplary embodiment;

FIG. 12 is a diagram illustrating an overlap degree transition table in the storage system as the exemplary embodiment;

FIG. 13 is a diagram illustrating an actual overlap degree/copy speed table in the storage system as the exemplary embodiment;

FIG. 14 is a diagram illustrating an advanced LUN table in the storage system as the exemplary embodiment;

FIG. 15 is a diagram illustrating an another node session table in the storage system as the exemplary embodiment;

FIG. 16 is a diagram illustrating a copy time estimation process in the storage system as the exemplary embodiment;

FIG. 17 is a diagram illustrating a data copy process in the storage system as the exemplary embodiment;

FIG. 18 is a diagram schematically illustrating a program configuration in the storage system as the exemplary embodiment;

FIG. 19 is a diagram illustrating an influence degree management process in the storage system as the exemplary embodiment;

FIG. 20 is a diagram illustrating an advanced LUN table used in the influence degree update process in the storage system as the exemplary embodiment;

FIG. 21 is a diagram illustrating a RAID group table used in the influence degree update process in the storage system as the exemplary embodiment;

FIG. 22 is a diagram illustrating an another node session table used in the influence degree update process in the storage system as the exemplary embodiment;

FIG. 23 is a diagram illustrating a first example of the actual overlap degree/copy speed table used in the influence degree update process in the storage system as the exemplary embodiment;

FIG. 24 is a diagram illustrating a first example of a relation between an overlap degree and a copy speed in the storage system as the exemplary embodiment;

FIG. 25 is a diagram illustrating a second example of the actual overlap degree/copy speed table used in the influence degree update process in the storage system as the exemplary embodiment;

FIG. 26 is a diagram illustrating a second example of a relation between an overlap degree and a copy speed in the storage system as the exemplary embodiment;

FIG. 27 is a diagram illustrating a third example of the actual overlap degree/copy speed table used in the influence degree update process in the storage system as the exemplary embodiment;

FIG. 28 is a diagram illustrating a third example of a relation between an overlap degree and a copy speed in the storage system as the exemplary embodiment;

FIG. 29 is a sequence diagram illustrating the copy time estimation process in the storage system as the exemplary embodiment;

FIG. 30 is a flowchart illustrating details of the copy time estimation process in the storage system as the exemplary embodiment;

FIG. 31 is a flowchart illustrating details of the copy time estimation process in the storage system as the exemplary embodiment;

FIG. 32 is a flowchart illustrating the influence degree update process in the storage system as the exemplary embodiment;

FIG. 33 is a diagram illustrating a copy time estimation process in a storage system as a related art; and

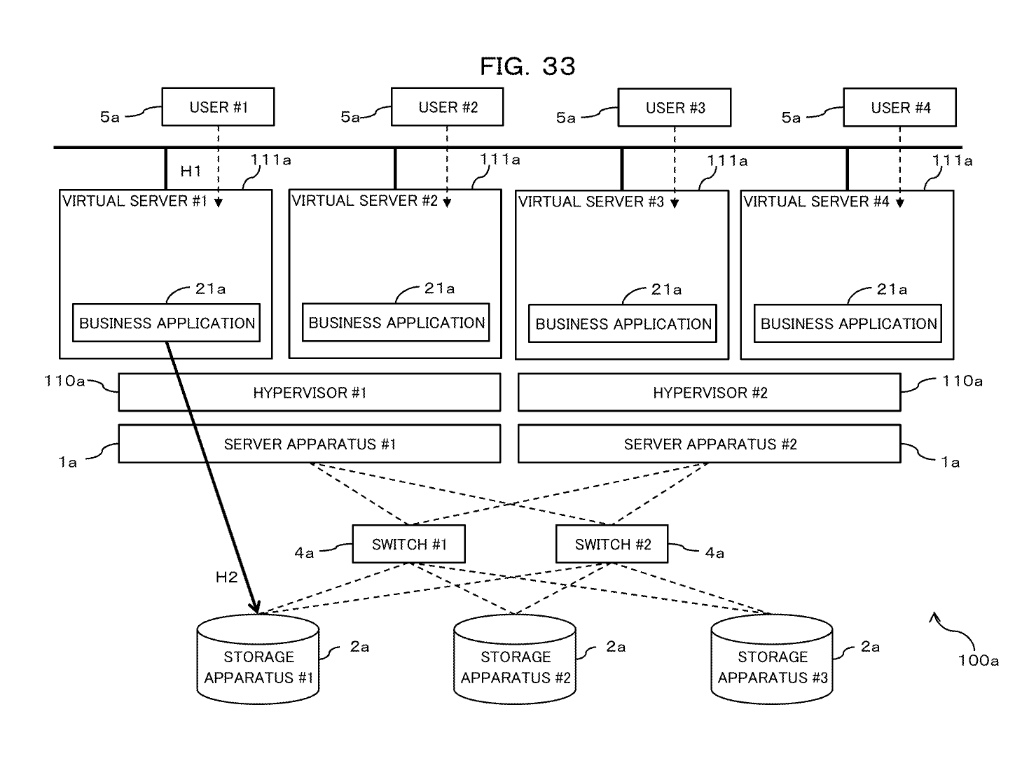

FIG. 34 is a diagram illustrating a data copy process in the storage system as a related art.

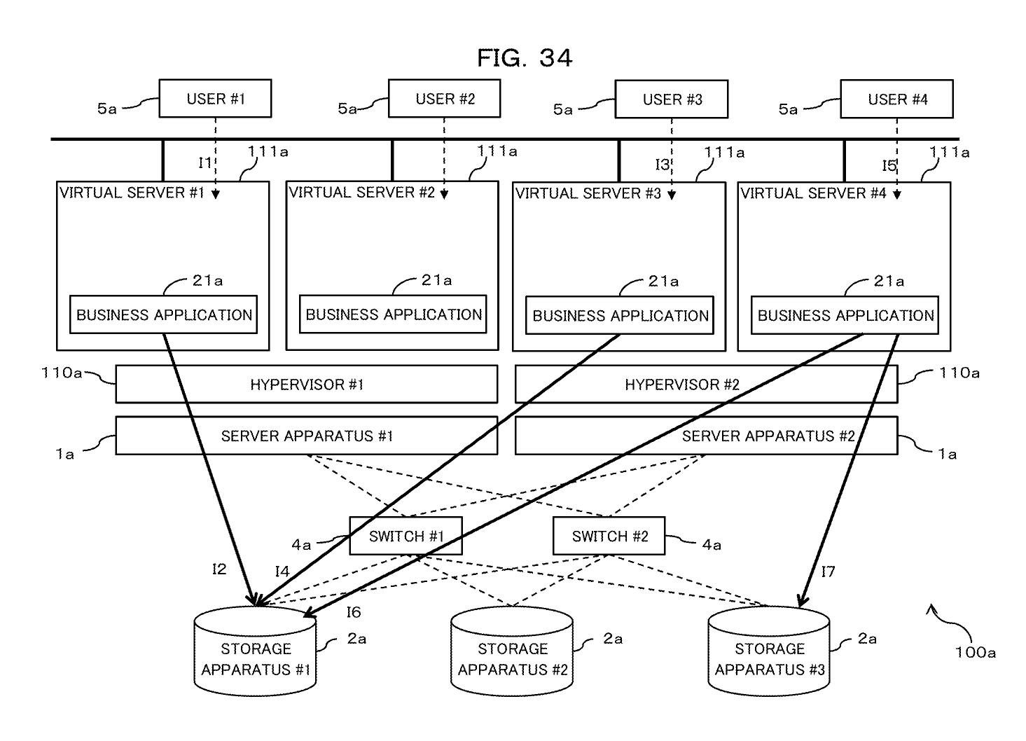

### DESCRIPTION OF EMBODIMENTS

Hereinafter, embodiments of an information processing apparatus, a data copy processing management method, and a data copy processing management program will be described with reference to the drawings. However, the following embodiments are given as merely exemplary, and it is not intended to exclude various modifications and various technical applications which are not specified in the embodiments. In other words, the embodiments can be implemented in various forms within a scope not departing from the spirit thereof.

Further, there is no purpose of exclusively including only the components in the drawings, but other functions can be included.

Hereinafter, the same reference numerals in the drawings represent the same components, and thus the redundant descriptions will not be repeated.

### [A] Exemplary Embodiment

### [A-1] System Configuration

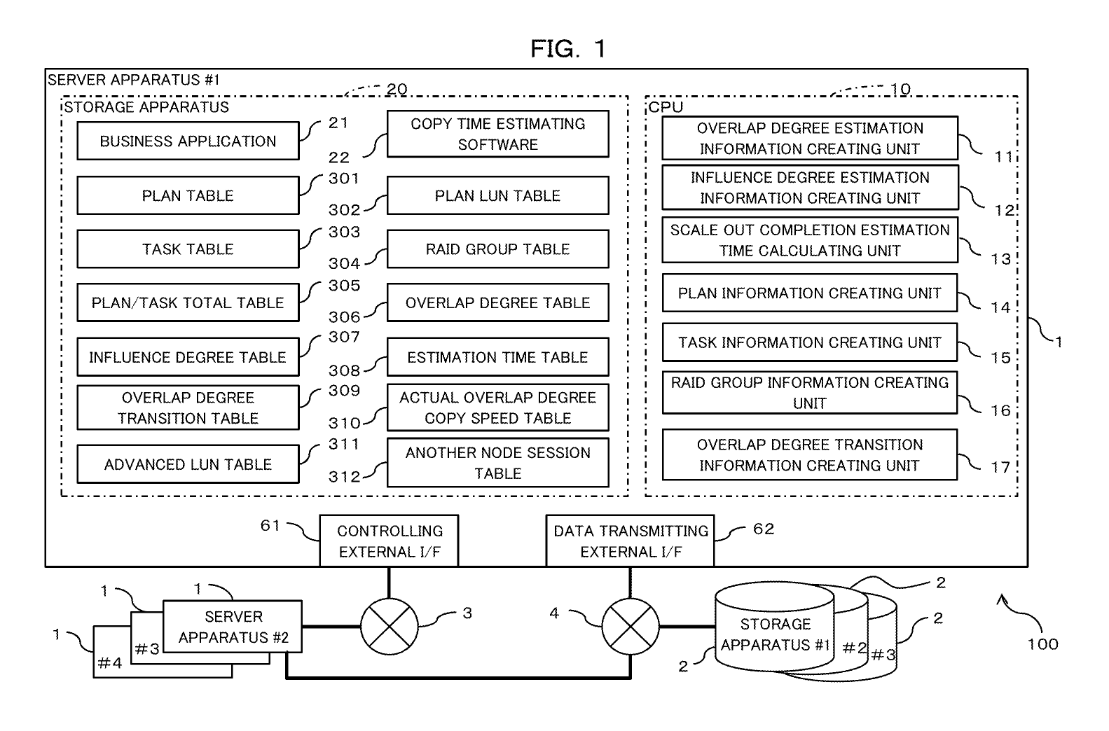

FIG. 1 is a diagram schematically illustrating functional configurations of a storage system as an exemplary embodiment.

A storage system 100 provides a storage area for a server apparatus (an information processing apparatus) 1 (for example, a RAID (redundant arrays of independent disks) system). As illustrated in FIG. 1, the storage system 100 includes a plurality (four in the illustrated example) of server apparatuses 1, a plurality (three in the illustrated example) of storage apparatuses 2, a controlling switch (router) 3, and a data transmitting switch (router) 4. The server apparatuses 1 are connected to communicate to each other through the controlling switch 3. Each server apparatus 1 is connected to the respective storage apparatuses 2 through the data transmitting switch 4 to communicate to each other. In the exemplary embodiment, each server apparatus 1 shares a business environment with other server apparatuses 1.

Hereinafter, when it is necessary to specify one of a plurality of server apparatuses, the server apparatus will be denoted by a “server apparatus #1”, a “server apparatus #2”, a “server apparatus #3”, or a “server apparatus #4”, and when an arbitrary server apparatus is indicated, it will be denoted by the “server apparatus 1”. Further, hereinafter, when it is necessary to specify one of the plurality of storage apparatuses, the storage apparatus will be denoted by a “storage apparatus #1”, a “storage apparatus #2”, a “storage apparatus #3” or a “storage apparatus #4”, and when an arbitrary storage apparatus is indicated, it will be denoted by the “storage apparatus 2”.

The storage apparatus 2 is a storage apparatus which stores data in a readable/writable manner (for example, a hard disk drive (HDD) or a solid state drive (SSD)). The respective storage apparatuses 2 include the same functional configurations.

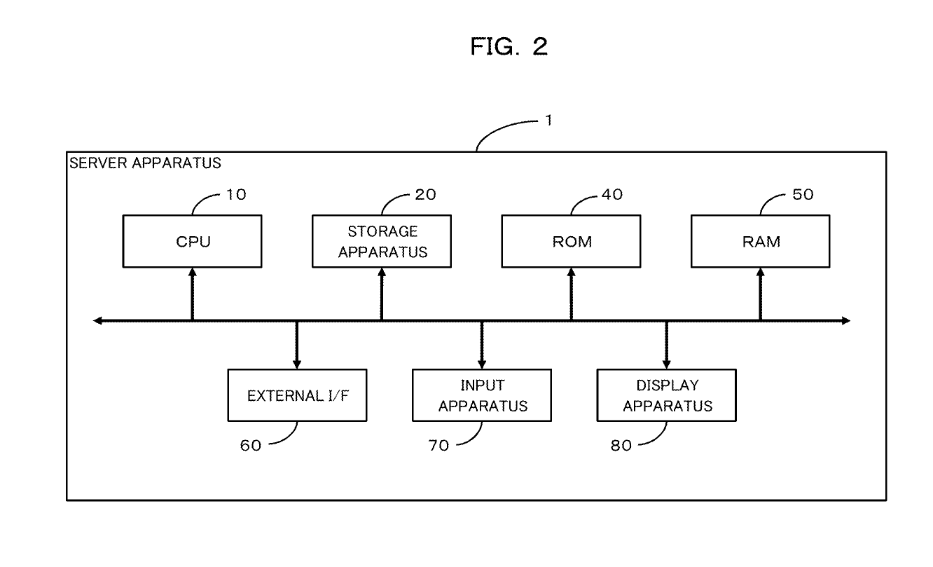

FIG. 2 is a diagram schematically illustrating functional configurations of a server apparatus in the storage system as the exemplary embodiment.

The server apparatus 1 is a computer which includes a server function, and includes a central processing unit (CPU) 10, a storage apparatus 20, a read only memory (ROM) 40, a random access memory (RAM) 50, an external interface (I/F) 60, an input apparatus 70, and a display apparatus 80 as illustrated in FIG. 2.

In FIG. 1, only some of the functional configurations of the server apparatus 1 illustrated in FIG. 2 are illustrated.

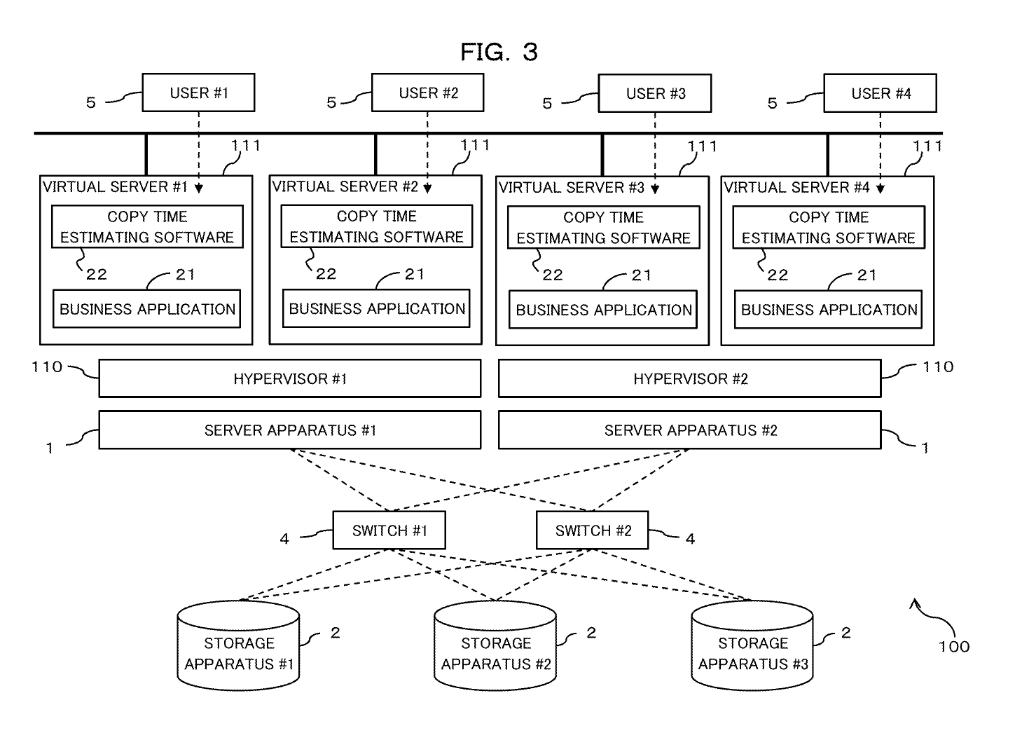

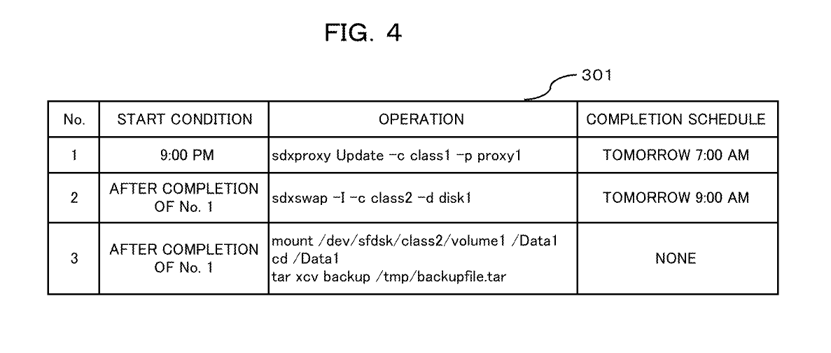

The input apparatus 70, for example, is a mouse, a track ball, or a keyboard, and the user 5 (to be described below using FIG. 3) performs various types of input operations through the input apparatus 70. In the exemplary embodiment, the user 5 instructs the server apparatus 1 to execute a copy time estimation process and a data copy process, and inputs a plan table 301 (to be described using FIG. 4) through the input apparatus 70.

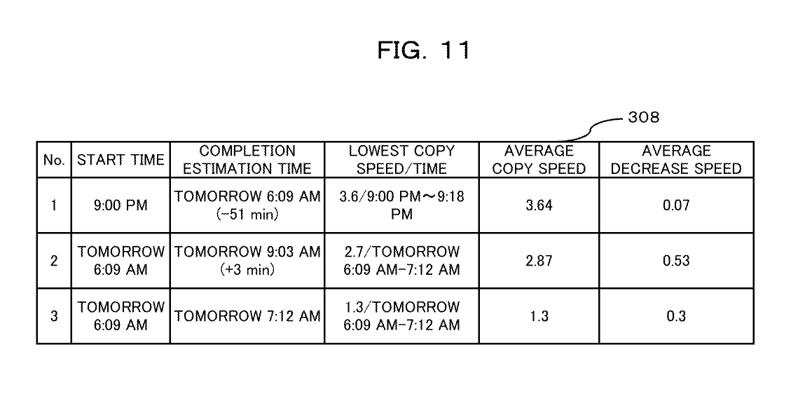

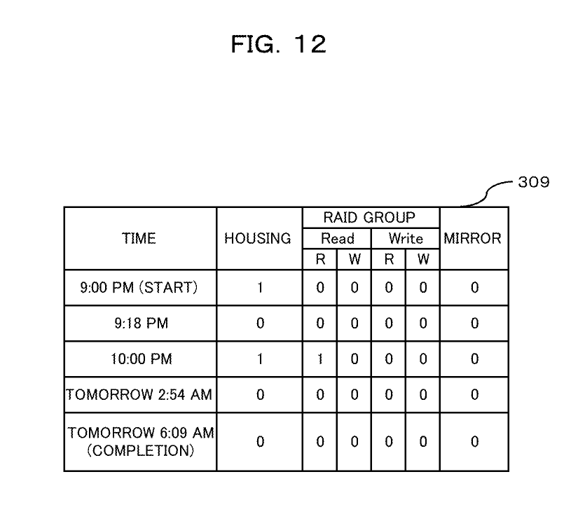

The display apparatus 80 is a display such as a liquid crystal display, a cathode ray tube (CRT), and an electronic paper display, and displays various types of information for the user 5. In the exemplary embodiment, the display apparatus 80 displays an estimation time table 308 (to be described below FIG. 11) and an overlap degree transition table 309 (to be described below FIG. 12) for the user 5.

In addition, the input apparatus 70 and the display apparatus 80 may be combined to each other (for example, a touch panel).

The external I/F 60 is an interface apparatus which connects the server apparatus 1 to a network and is used to make communication with the other server apparatuses 1 and the storage apparatus 2 through the network. Examples of the external I/F 60 include various types of interface cards corresponding to network standards such as a wired local area network (LAN), a wireless LAN, and a wireless wide area network (WWAN). As illustrated in FIG. 1, the external I/F 60 functions as a controlling external I/F 61 and a data transmitting external I/F 62. The controlling external I/F 61 is an interface apparatus to make communication with the other server apparatuses 1 through the controlling switch 3, and the data transmitting external I/F 62 is an interface apparatus to make communication with the storage apparatus 2 through the data transmitting switch 4.

The ROM 40 is a storage apparatus in which a program such as a basic input/output system (BIOS) is written. A software program on the ROM 40 is read out to the CPU 10 for execution. Further, the RAM 50 is a storage apparatus which is used as a primary recording memory or a working memory.

The storage apparatus 20 is a well-known apparatus in which data is stored in a readable/writable manner (for example, an HDD or an SSD). In the exemplary embodiment, as illustrated in FIG. 1, the storage apparatus 20 includes recording areas for storing information of a business application 21, a copy time estimating software 22, a plan table (plan) 301, a plan logical unit number (LUN) table (plan information) 302, a task table (task information) 303, a RAID group table (RAID group information) 304, a plan/task total table 305, an overlap degree table (overlap degree estimation information) 306, an influence degree table (influence degree estimation information) 307, an estimation time table (data copy completion estimation time) 308, an overlap degree transition table (overlap degree transition information) 309, an actual overlap degree/copy speed table 310, an advanced LUN table 311, and an another node session table 312.

The plan table 301, the plan LUN table 302, the task table 303, the RAID group table 304, the plan/task total table 305, the overlap degree table 306, the influence degree table 307, the estimation time table 308, the overlap degree transition table 309, the actual overlap degree/copy speed table 310, the advanced LUN table 311, and the another node session table 312 will be described below using FIGS. 4 to 15.

The business application 21 and the copy time estimating software 22 function when executed in the CPU 10.

The business application 21 performs an I/O process such as the data copy process (a backup process) on the storage apparatus 2. Further, the business application 21 includes an interface for acquiring information from the copy time estimating software 22. The user 5 inputs information on the business to be performed later or periodically in the business application 21 through the input apparatus 70.

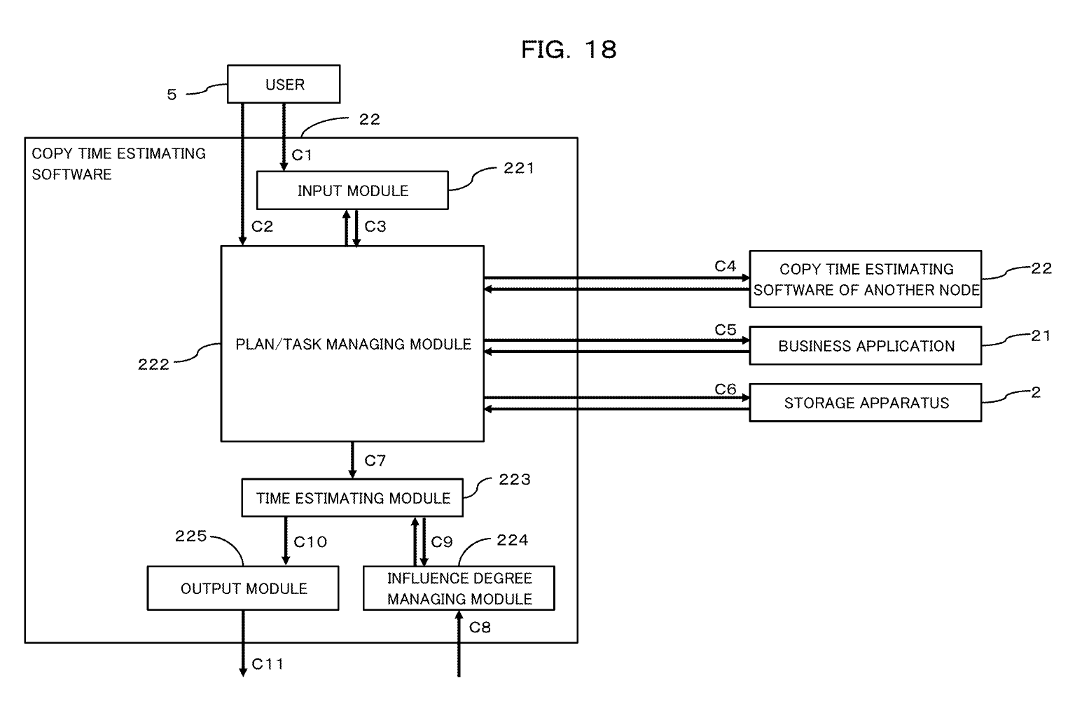

The copy time estimating software 22 estimates a completion time of the data copy process, and an overlap degree of tasks in the data copy process. For example, the storage apparatus 20 of the server apparatus 1 stores information (Internet Protocol (IP) address and the like) of the other server apparatuses 1 which share a business environment. Then, the copy time estimating software 22 refers to the IP addresses and the like stored in the storage apparatus 20, and accesses the other server apparatuses 1 using the IP addresses to acquire information for estimating the completion time of the data copy process and the overlap degree of tasks from the other server apparatuses 1. In addition, the IP addresses and the like, for example, are input to the server apparatus 1 by an administrator at the time of constructing the business environment. Further, in a case where a new server apparatus 1 is added to the storage system 100, for example, the IP addresses and the like of the existing server apparatuses 1 may be input to the added server apparatus 1, and the IP address and the like may be automatically added to the existing server apparatuses 1. The details of the copy time estimating software 22 will be described below with reference to FIG. 18.

The CPU 10 is a processing apparatus which performs various controls and calculations, and an operating system (OS) and a program stored in the ROM 40 and the storage apparatus 20 are executed to realize various functions. In other words, as illustrated in FIG. 1, the CPU 10 functions as an overlap degree estimation information creating unit 11, an influence degree estimation information creating unit 12, a completion estimation time calculating unit 13, a plan information creating unit 14, a task information creating unit 15, a RAID group information creating unit 16, and an overlap degree transition information creating unit 17.

In addition, the program (a data copy processing management program) for realizing the functions of the overlap degree estimation information creating unit 11, the influence degree estimation information creating unit 12, the completion estimation time calculating unit 13, the plan information creating unit 14, the task information creating unit 15, the RAID group information creating unit 16, and the overlap degree transition information creating unit 17, for example, is provided in a form of a computer-readable recording medium such as a flexible disk, a CD (a CD-ROM, a CD-R, a CD-RW, and the like), a DVD (a DVD-ROM, a DVD-RAM, a DVD-R, a DVD+R, a DVD-RW, a DVD+RW, an HD DVD, and the like), a Blu-ray disk, a magnetic disk, an optical disk, and a magneto-optical disk. Then, the computer reads the program out of the recording medium through a reading apparatus (not illustrated), transfers the program to an internal recording apparatus or an external recording apparatus for storage, and uses the program. Further, for example, once the program is stored in a storage apparatus (recording medium) such as a magnetic disk, an optical disk, and a magneto-optical disk, the program may be provided to the computer from the storage apparatus through a communication path.

When the functions as the overlap degree estimation information creating unit 11, the influence degree estimation information creating unit 12, the completion estimation time calculating unit 13, the plan information creating unit 14, the task information creating unit 15, the RAID group information creating unit 16, and the overlap degree transition information creating unit 17 are realized, the program stored in an internal storage apparatus (the storage apparatus 20 in the embodiment) is executed by a microprocessor of the computer (the CPU 10 in the embodiment). At this time, the program recorded in the recording medium may be executed after being reading out of the computer.

The plan information creating unit 14 creates the plan LUN table 302 in which the plan table 301 indicating the data copy process executed for the storage apparatus 2 by each server apparatus 1 is associated with a LUN of the storage apparatus 2 relating to a data copy processing plan.

The task information creating unit 15 creates the task table 303 which shows tasks executed by the storage apparatus 2.

The RAID group information creating unit 16 creates the RAID group table 304 which shows the LUN and a performance value of each RAID group which is defined in the storage apparatus 2.

The overlap degree estimation information creating unit 11 creates the overlap degree table 306 which shows an estimated overlap degree of tasks executed in the storage apparatus 2 by each server apparatus 1. Specifically, the overlap degree estimation information creating unit 11 creates the overlap degree table 306 based on the plan LUN table 302, the task table 303, and the RAID group table 304. Further, the overlap degree estimation information creating unit 11 creates the overlap degree table 306 based on the overlap degree between a reading operation and a writing operation in the same RAID group.

The influence degree estimation information creating unit 12 creates the influence degree table 307 which shows an influence degree on the performance of the storage apparatus 2 in which the overlapping of tasks is estimated to occur.

The completion estimation time calculating unit 13 creates the estimation time table 308 based on the overlap degree table 306 and the influence degree table 307. Specifically, the completion estimation time calculating unit 13 calculates a data copy processing capacity per unit time based on the overlap degree in the overlap degree table 306 and the performance value in the RAID group table 304, each of which is weighted by the influence degree in the influence degree table 307. Then, the completion estimation time calculating unit 13 creates the estimation time table 308 based on the data copy processing capacity calculated per unit time.

The overlap degree transition information creating unit 17 creates the overlap degree transition table 309 indicating a transition of the overlap degree of tasks in each time zone of the data copy processing plan based on the data copy processing capacity per unit time calculated by the completion estimation time calculating unit 13.

FIG. 3 is a diagram schematically illustrating an exemplary operation in the storage system as the exemplary embodiment.

In the exemplary embodiment, a server to execute a business application may be the physical server apparatus 1 as illustrated in FIG. 1, or may be a virtual server 111 as illustrated in FIG. 3. In the following description, the server to execute the business application is assumed as the virtual server 111.

The storage system 100 illustrated in FIG. 3 includes two server apparatuses 1, two data transmitting switches 4, and three storage apparatuses 2. Then, the server apparatus 1 accesses any one (the storage apparatus 2) of the three storage apparatuses 2 through any one (the data transmitting switch 4) of the two data transmitting switches 4.

Hereinafter, when it is necessary to specify one of the plurality of server apparatuses, the server apparatus will be simply denoted by the “server apparatus #1” or the “server apparatus #2”, and when an arbitrary server apparatus is indicated, it will be denoted by the “server apparatus 1”. Further, hereinafter, when it is necessary to specify one of a plurality of data transmitting switches, the data transmitting switch will be simply denoted by a “switch #1” or a “switch #2”, and when an arbitrary data transmitting switch is indicated, it will be denoted by the “data transmitting switch 4”. Furthermore, hereinafter, when it is necessary to specify one of the plurality of storage apparatuses, the storage apparatus will be simply denoted by the “storage apparatus #1”, the “storage apparatus #2”, or the “storage apparatus #3”, and when an arbitrary storage apparatus is indicated, it will be denoted by the “storage apparatus 2”.

The server apparatus 1 develops a hypervisor 110. Specifically, the server apparatuses #1 and #2 develop hypervisors #1 and #2, respectively.

Hereinafter, when it is necessary to specify one of a plurality of hypervisors, the hypervisor will be simply denoted by the “hypervisor #1” or the “hypervisor #2”, and when an arbitrary hypervisor is indicated, it will be denoted by the “hypervisor 110”.

Furthermore, the server apparatus 1 develops one or more (two in the example illustrated in FIG. 3) virtual servers 111 on the developed hypervisor 110. Specifically, the server apparatus #1 develops virtual servers #1 and #2 on the developed hypervisor #1, and the server apparatus #2 develops virtual servers #3 and #4 on the developed hypervisor #2. In this way, the storage system 100 illustrated in FIG. 3 is configured in an environment in which the virtual servers 111 and the storage apparatuses 2 are provided on a multiple-to-multiple basis.

Hereinafter, when it is necessary to specify one of a plurality of virtual servers, the virtual server will be simply denoted by the “virtual server #1”, the “virtual server #2”, the “virtual server #3”, or the “virtual server #4”, and when an arbitrary virtual server is indicated, it will be denoted by the “virtual server 111”.

Then, the virtual server 111 executes the business application 21 and the copy time estimating software 22. The virtual server 111 executes an I/O process such as the data copy process on the storage apparatus 2 through the business application 21, and executes the copy time estimation process through the copy time estimating software 22.

Four users 5 illustrated in FIG. 3 instruct the virtual server 111 to execute the data copy process to the storage apparatus 2 or the I/O process such as the copy time estimation process. Specifically, the users #1 to #4 instruct the virtual servers #1 to #4 to execute the data copy process to the storage apparatus 2 or the I/O process such as the copy time estimation process, respectively.

Hereinafter, when it is necessary to specify one of a plurality of users, the user will be simply denoted by the “user #1”, the “user #2”, the “user #3”, or the “user #4”, and when an arbitrary user is indicated, it will be denoted by the “user 5”.

In addition, in the example illustrated in FIG. 3, the description has been made about the configuration in which the storage system 100 includes two server apparatuses 1, two data transmitting switches 4, and three storage apparatuses 2, and each server apparatus 1 develops two virtual servers 111, but the embodiment is not limited thereto. The numbers of server apparatuses 1, data transmitting switches 4, and storage apparatuses 2 which are included in the storage system 100 can be variously changed, and the number of virtual servers 111 developed by each server apparatus 1 can also be variously changed.

As illustrated in FIG. 3, in a case where each server apparatus 1 develops the plurality of virtual servers 111, the developed virtual server 111 has functions as the overlap degree estimation information creating unit 11, the influence degree estimation information creating unit 12, the completion estimation time calculating unit 13, the plan information creating unit 14, the task information creating unit 15, the RAID group information creating unit 16, and the overlap degree transition information creating unit 17.

FIG. 4 is a diagram illustrating a plan table in the storage system as the exemplary embodiment.

The plan table 301 shows the data copy process which is executed on the storage apparatus 2 by each server apparatus 1. The user 5 inputs the plan table 301 in the virtual server 111 through the input apparatus 70.

In the example illustrated in FIG. 4, three tasks No. 1 to 3 are input to the plan table 301. The task No. 1 starts at time 9:00 p.m., executes an operation defined by “sdxproxy Update -c class1-p proxy1”, and is scheduled to be completed before 7:00 a.m. tomorrow. In addition, the operation “sdxproxy Update -c class1-p proxy1” is a command to instruct the business application 21 to perform the data copy process to the storage apparatus 2. Further, the task No. 2 starts after the task No. 1 is completed, executes an operation defined by “sdxswap -I -c class2 -d disk1”, and is scheduled to be completed before 9:00 a.m. tomorrow. In addition, the operation “sdxswap -I -c class2-d disk1” is a command to instruct the business application 21 to exchange a disk in the storage apparatus 2. Furthermore, the task No. 3 starts after the task No. 1 is completed, and executes an operation defined by “mount/dev/sfdsk/class2/volume1/Data1 cd/Data1 tar xcv backup/tmp/backupfile.tar”. In addition, the operation “mount/dev/sfdsk/class2/volume1/Data1 cd/Data1 tar xcv backup/tmp/backupfile.tar” is a command to instruct the business application 21 to operate the OS to write data in the device.

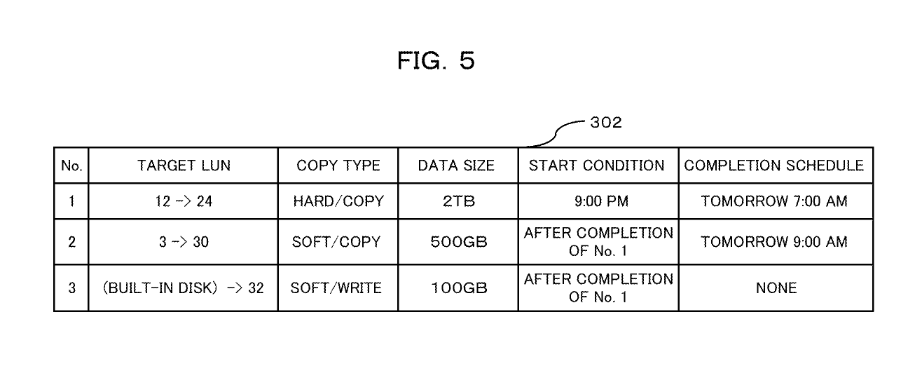

FIG. 5 is a diagram illustrating a plan LUN table in the storage system as the exemplary embodiment.

The plan LUN table 302 is information in which the plan table 301 and the LUN of the storage apparatus 2 related to the data copy processing plan are associated. The plan LUN table 302 is associated with the LUN which is used in each command.

In the example illustrated in FIG. 5, the tasks No. 1 to 3 are registered in the plan LUN table 302, these registered tasks No. 1 to 3 are associated with the tasks No. 1 to 3 illustrated in FIG. 4, respectively. The information of the task No. 1 shows writing data read from a LUN 12 into a LUN 24, hard/copy, 2 TB as a data size, 9:00 p.m. as a start condition, and tomorrow 7:00 a.m. as a completion schedule. In addition, the hard/copy means a copy operation performed in the housing of the storage apparatus 2. Further, the information of the task No. 2 shows writing data read from a LUN 3 into a LUN 30, soft/copy, 500 GB as a data size, after completion of the task No. 1 as a start condition, and tomorrow 9:00 a.m. as a completion schedule. In addition, the soft/copy means a copy operation performed through the server apparatus 1. Furthermore, the information of the task No. 3 shows writing data read from a built-in disk (for example, the storage apparatus 20) of the server apparatus 1 into a LUN 32, soft/write, 100 GB as a data size, after completion of the task No. 1 as a start condition, and no setting as a completion schedule. In addition, the soft/write means a write operation of writing data to be stored in the server apparatus 1 into the storage apparatus 2.

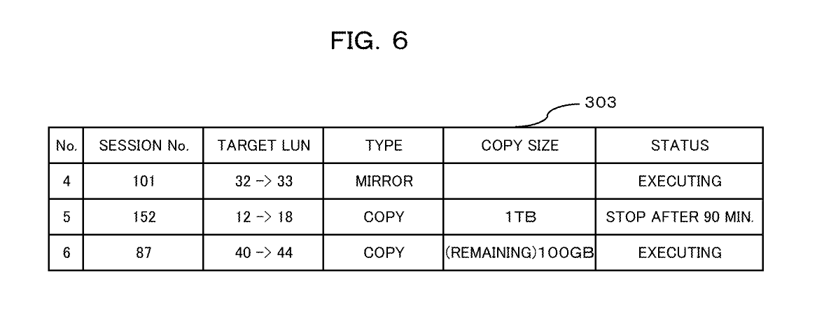

FIG. 6 is a diagram illustrating a task table in the storage system as the exemplary embodiment.

The task table 303 shows tasks which are already instructed to the storage apparatus 2 and performed from now on by the storage apparatus 2, and tasks which are executing.

In the example illustrated in FIG. 6, tasks No. 4 to 6 are registered in the task table 303. The information of the task No. 4 shows 101 as a session number, writing data read from a LUN 32 into a LUN 33, mirroring, and executing. In addition, the session number represents a number for managing a task in the storage apparatus 2. Further, the information of the task No. 5 shows 152 as a session number, writing data read from a LUN 12 into a LUN 18, copy, 1 TB as a copy size, and stop after 90 minutes. Furthermore, the information of the task No. 6 shows 87 as a session number, writing data read from a LUN 40 into a LUN 44, copy, remaining 100 GB as a copy size, and executing.

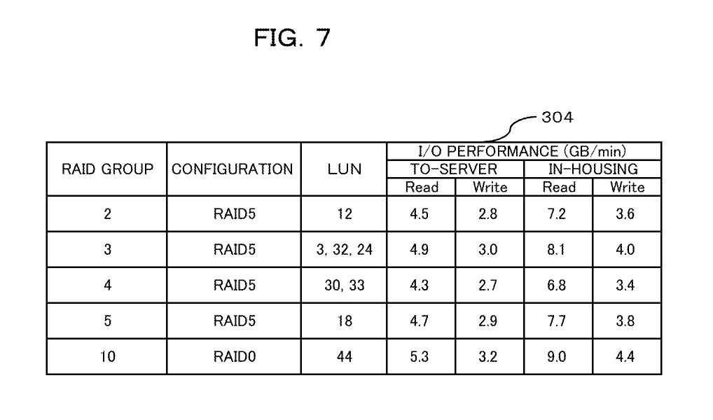

FIG. 7 is a diagram illustrating a RAID group table in the storage system as the exemplary embodiment.

The RAID group table 304 shows the LUN and the performance value (I/O performance) of each RAID group which is defined in the storage apparatus 2. In the RAID group table 304, the LUN used in each task in a plan of the data copy process is associated with information of the RAID group. In addition, the performance value may be acquired from the storage apparatus 2 through a performance acquisition I/F (not illustrated) included in the server apparatus 1, or may be input by the user 5 in advance.

In the example illustrated in FIG. 7, information relating to the RAID groups 2 to 5, and 10 is registered in the RAID group table 304. For example, the information of the RAID group 2 shows a RAID 5 configuration, including a LUN 12, 4.5 GB/min and 2.8 GB/min as a read performance and a write performance on the server apparatus 1, respectively, and 7.2 GB/min and 3.6 GB/min as a read performance and a write performance in the housing, respectively. Further, the configurations, the LUNs, and the I/O performances of the RAID groups 3 to 5, and 10 are shown similarly to those of the RAID group 2.

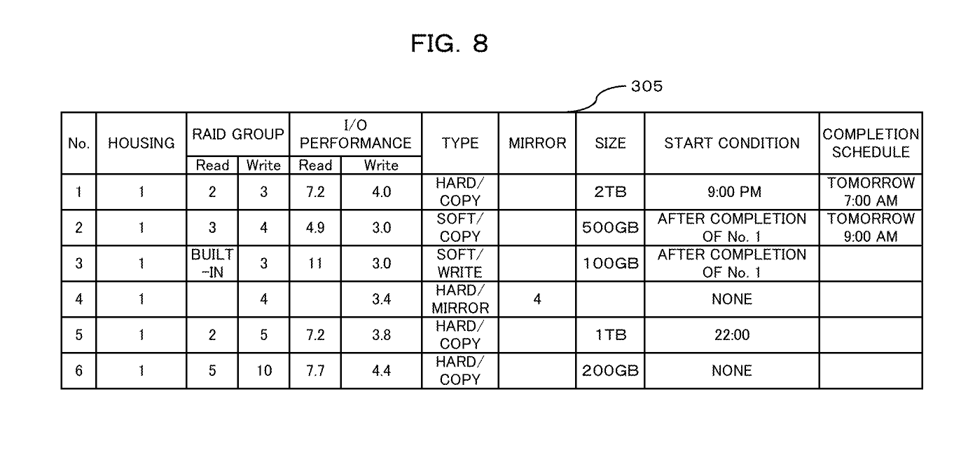

FIG. 8 is a diagram illustrating a plan/task total table in the storage system as the exemplary embodiment.

The plan/task total table 305 is information in which data necessary to estimate the time required for the copy process are arranged with respect to the plan of the data copy process and the task on the storage apparatus 2. The plan/task total table 305 is created based on the plan LUN table 302, the task table 303, and the RAID group table 304. In addition, the performance value of the built-in disk may be autonomically measured by the server apparatus 1, or may be input by the user 5 in advance.

In the example illustrated in FIG. 8, the tasks No. 1 to 6 are registered in the plan/task total table 305. These registered tasks No. 1 to 3 respectively correspond to the tasks No. 1 to 3 illustrated in FIG. 4, and the tasks No. 4 to 6 respectively correspond to the task No. 4 to 6 illustrated in FIG. 6. For example, the task No. 1 shows a process performed in a housing 1, writing data read from the RAID group 2 into the RAID group 3, 7.2 GB/min as a read performance, 4.0 GB/min as a write performance, hard/copy, 2 TB as a copy size, 9:00 p.m. as a start condition, and tomorrow 7:00 a.m. as a completion condition. Further, for example, the task No. 3 shows a process performed in the housing 1, writing data read from the built-in disk into the RAID group 3, 11 GB/min as a read performance, 3.0 GB/min as a write performance, soft/write, 100 GB as a write size, and after the completion of the task No. 1 as a start condition. Furthermore, for example, the task No. 4 shows a process performed in the housing 1, writing into the RAID group 4, 3.4 GB/min as a write performance, and a mirroring operation in the RAID group 4. Further, the respective information of the tasks No. 2, 5, and 6 is also the same as that of the tasks No. 1, 3, and 4.

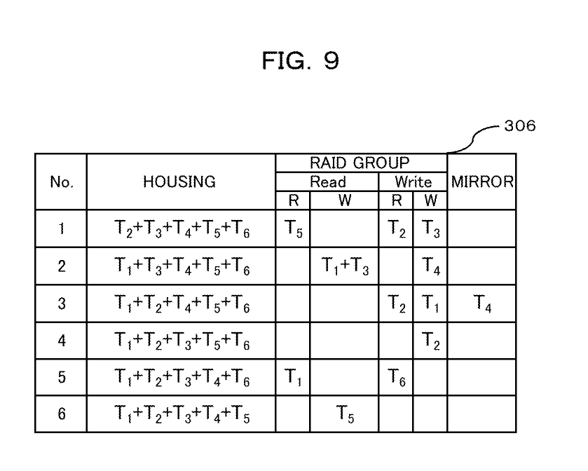

FIG. 9 is a diagram illustrating an overlap degree table in the storage system as the exemplary embodiment.

The overlap degree table 306 shows the estimated overlap degree of tasks executed in the storage apparatus 2 by each server apparatus 1. Herein, the overlap degree is a numerical value indicating a degree of sharing resources of the storage apparatus 2 between the tasks (plans) of the data copy process. For example, in a case where the tasks (plans) of three data copy processes use the same housing, the overlap degree becomes 3. Specifically, the overlap degree table 306 is created based on the plan LUN table 302, the task table 303, and the RAID group table 304. Further, the overlap degree table 306 is created based on the overlap degree between the reading operation and the writing operation in the same RAID group. The overlap degree table 306 illustrated in FIG. 9 shows the overlapping of tasks which has a possibility to occur during a period from start to completion of the data copy process, and the overlap degree between the respective tasks are different in time. The copy time estimating software 22 calculates the overlap degree of tasks per unit time based on the overlap degree table 306.

In the example illustrated in FIG. 9, the tasks No. 1 to 6 is registered in the overlap degree table 306, and these registered tasks No. 1 to 6 correspond to the tasks No. 1 to 6 illustrated in FIG. 8, respectively. Further, T₁ to T₆ in the overlap degree table 306 shows the tasks No. 1 to 6, respectively. For example, the task No. 1 shows the overlapping of the tasks No. 2 to 6 in the housing, and the overlapping the reading operation with the reading operation of task No. 5 and the overlapping the writing operation with the reading operation of the task No. 2 and the writing operation of task No. 3 in the same RAID group. Further, for example, the task No. 2 shows the overlapping of the tasks No. 1, 3 to 6 in the housing, and the overlapping the reading operation with the writing operations of the tasks No. 1 and 3 and the overlapping the writing operation with the writing operation of the task No. 4 in the same RAID group. Furthermore, for example, the task No. 3 shows the overlapping of the tasks No. 1, 2, 4 to 6 in the housing, and the overlapping the writing operation with the reading operation of the task No. 2 and the writing operation of the task No. 1 and the overlapping with the task No. 4 by a mirroring operation in the same RAID group. Further, the housing in which the overlapping of the tasks No. 4 to 6 occurs and the processes (the reading operation, the writing operation, or the mirroring operation) are shown similarly to the housing in which the overlapping of the tasks No. 1 to 3 occurs and the processes therein.

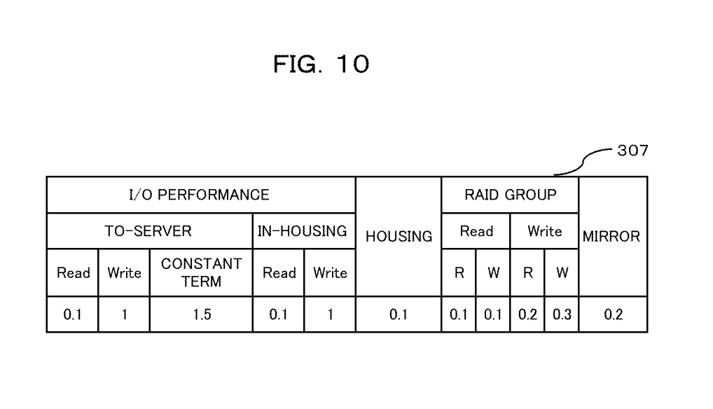

FIG. 10 is a diagram illustrating an influence degree table in the storage system as the exemplary embodiment.

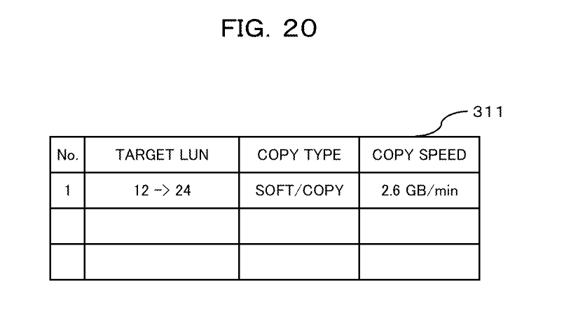

The influence degree table 307 shows the influence degree on the performance of the storage apparatus 2 in which the overlapping of tasks is estimated to occur. Parameters used in calculating the copy size per unit time are registered in the influence degree table 307. The copy time estimating software 22 monitors an I/O process on the storage apparatus 2 and a copy process in the storage housing, and updates parameters the influence degree table 307 based on the monitoring result. A method of updating the influence degree table 307 will be described using FIGS. 20 to 28.

In the example illustrated in FIG. 10, the values in the I/O performance column show the influence degree on a fundamental performance of the storage apparatus 2, and the fundamental performance value is expressed as the following equation.

$$Fundamental performance value ( GB \text{/} min ) = To \text{-} server . Read \times To \text{-} server . Read Influence degree + To \text{-} server . Write \times To \text{-} server . Write Influence degree - To \text{-} server . Constant term + In \text{-} housing . Read \times In \text{-} housing . Read Influence degree + In \text{-} housing . Write \times In \text{-} housing . Write Influence degree$$

In the equation indicating the fundamental performance value, the values in the I/O performance column of the plan/task total table 305 illustrated in FIG. 8 are substituted into To-server.Read, To-server.Write, In-housing.Read, and In-housing.Write. For example, since the task No. 1 illustrated in FIG. 8 corresponds to hard/copy which is executed in the housing of the storage apparatus 2, the values are set as follows: To-server.Read=0, To-server.Write=0, In-housing.Read=7.2, and In-housing.Write=4.0. Further, for example, since the task No. 2 illustrated in FIG. 8 corresponds to soft/copy which is executed through the server apparatus 1, the values are set as follows: To-server.Read=4.9, To-server.Write=3.0, In-housing.Read=0, and In-housing.Write=0. In other words, in a case where the type of the copy operation, the writing operation, or the mirroring operation is hard, the values of To-server.Read and To-server.Write become 0, and in a case where the type of the copy operation, the writing operation, or the mirroring operation is soft, the values of In-housing.Read and In-housing.Write become 0.

In the equation indicating the fundamental performance value, the values in the I/O performance column of the influence degree table 307 illustrated in FIG. 10 are substituted into To-server.Read Influence degree, To-server.Write Influence degree, To-server.Constant term, In-housing.Read Influence degree, and In-housing.Write Influence degree. In other words, the values are set as follows: To-server.Read Influence degree=0.1, To-server.Write Influence degree=1, To-server.Constant term=1.5, In-housing.Read=0.1, and In-housing.Write=1. Further, in a case where the type of the copy operation, the wiring operation, or the mirroring operation is hard, the values of To-server.Read Influence degree, To-server.Write Influence degree and To-server.Constant term become 0. On the other hand, in a case where the type of the copy operation, the writing operation, or the mirroring operation is soft, the values of In-housing.Read Influence degree and In-housing.Write become 0.

For example, the fundamental performance value of the task No. 1 illustrated in FIG. 8 becomes as follows.

Fundamental performance value=0×0+0×0−0+7.2×0.1+4.0×1=4.72(GB/min)

Further, for example, the fundamental performance value of the task No. 2 illustrated in FIG. 8 becomes as follows.

Fundamental performance value=4.9×0.1+3.0×1−1.5+0×0+0×0=1.99(GB/min)

In the example illustrated in FIG. 10, the values of the housing, the RAID group, and the mirror indicate the influence degrees on a speed reduction by the overlapping of the tasks in the storage apparatus 2, and the decrease speed is expressed as the following equation.

$$Reduced speed ( GB \text{/} min ) = Housing overlap degree \times Housing influence degree + RAID group . Read . R Overlapping degree \times RAID group . Read . R Influence degree + RAID group . Read . W Overlapping degree \times RAID group . Read . W Influence degree + RAID group . Write . R Overlapping degree \times RAID group . Write . R Influence degree + RAID group . Write . W Overlapping degree \times RAID group . Write . W Influence degree + Mirror decrease speed$$

Herein, the mirror decrease speed is a value indicating a speed reduction occurring in the storage apparatus 2 under the influence of the mirroring operation, and is expressed as the following equation.

$$Mirror decrease speed ( GB \text{/} min ) = Mirror influence \times {\sum }^{Mirror session} \frac{1}{Copy size per unit time of mirror task} \qquad [ Mathematical Formula 1 ]$$

In the equation indicating the decrease speed, the housing overlap degree, the RAID group.Read.R Overlap degree, the RAID group.Read.W Overlap degree, the RAID group.Write.R Overlap degree, the RAID group.Write.W Overlap degree, and the mirror decrease speed are substituted based on the overlap degree table 306 illustrated in FIG. 9. For example, in the task No. 1 illustrated in FIG. 9, the values are as follows: Housing overlap degree=5, RAID group.Read.R Overlap degree=1, RAID group.Read.W Overlap degree=0, RAID group.Write.R Overlap degree=1, RAID group.Write.W Overlap degree=1, and Mirror overlap degree=0. Then, the copy time estimating software 22 calculates the overlap degree per unit time for each overlap degree, and substitutes the overlap degree into the equation. For example, in the task No. 1 illustrated in FIG. 9, in a case where Housing overlap degree=5, RAID group.Read.R Overlap degree=1, RAID group.Write.R Overlap degree=1, and RAID group.Write.W Overlap degree=1 are set at time T, the decrease speed becomes as follows.

Decrease speed=5×0.1+1×0.1+0×0.1+1×0.2+1×0.3+0=1.1(GB/min)

The equation indicating the mirror decrease speed is applied to the task (for example, the task No. 3 illustrated in FIG. 9) of which the mirror overlap degree is set in the overlap degree table 306. In the equation indicating the mirror decrease speed, the value in the mirror column of the influence degree table 307 is substituted into the mirror influence degree. Further, the operation denoted by symbol Σ indicates that the reciprocals of the copy sizes per unit time of the tasks (for example, T₄ illustrated in FIG. 9) which are set in the mirror column of the overlap degree table 306 are summed up as many as the number of mirror sessions (the overlap degrees, the mirror tasks). For example, the task No. 3 illustrated in FIG. 9 is overlapped with the task No. 4 by the mirroring operation. Then, for example, at time T, the task No. 3 illustrated in FIG. 9 is overlapped with the task No. 4 by the mirroring operation. Further, and in a case where the copy size per unit time of the task No. 4 is 3.4 GB/min, the mirror decrease speed becomes as follows.

Mirror decrease speed=0.2× 1/3.4≈0.06(GB/min) [Mathematical Formula 2]

In addition, in a case where a plurality of tasks are set in the mirror column of the influence degree table 307, the reciprocal of the copy size per unit time of each task is summed up in the operation denoted by symbol E. Then, in the task No. 3 illustrated in FIG. 9, in a case where Housing overlap degree=5, RAID group.Write.R Overlap degree=1, and RAID group.Write.W Overlap degree=1 are set at time T, the decrease speed becomes as follows.

Decreasespeed≈5×0.1+0×0.1+1×0.2+1×0.3+0.06=1.06(GB/min) [Mathematical Formula 3]

Then, the copy size per unit time can be calculated as follows based on the fundamental performance value and the decrease speed.

Copy size per unit time (GB/min)=Fundamental performance value−Decrease speed

For example, in the task No. 1 illustrated in FIG. 9, in a case where Housing overlap degree=5, RAID group.Read.R Overlap degree=1, RAID group.Write.R Overlap degree=1, and RAID group.Write.W Overlap degree=1 are set at time T, Decrease speed=1.1 GB/min is set as described above. Further, in the task No. 1 illustrated in FIG. 8, Fundamental performance value=4.72 GB/min is set. Then, the copy size per unit time becomes as follows.

Copy size per unit time=4.72−1.1=3.62(GB/min)

FIG. 11 is a diagram illustrating an estimation time table in the storage system as the exemplary embodiment.

The estimation time table 308 is created based on the overlap degree table 306 and the influence degree table 307. Specifically, the data copy processing capacity per unit time is calculated based on the overlap degree in the overlap degree table 306 and the performance value in the RAID group table 304, in which the overlap degree and the performance value each are weighted by the influence degree in the influence degree table 307. Then, the estimation time table 308 is calculated based on the calculated data copy processing capacity per unit time. The copy time estimating software 22 presents the estimation time table 308 to the user 5 through the display apparatus 80.

In the example illustrated in FIG. 11, the tasks No. 1 to 3 are registered in the estimation time table 308, these registered tasks No. 1 to 3 correspond to the tasks No. 1 to 3 illustrated in FIGS. 4, 5, 8, and 9, respectively.

The task No. 1 shows the values as follows: 9:00 p.m. as a start time, tomorrow 6:09 a.m. as a completion estimation time, 3.6 GB/min as the lowest copy speed during a period of time from 9:00 p.m. to 9:18 p.m., 3.64 GB/min as an average copy speed, and 0.07 GB/min as an average decrease speed. Herein, the average decrease speed is a value indicating an average in speed reduced from a maximum I/O performance value (the fundamental performance value) in the storage apparatus 2. The parenthesized value in the completion estimation time column indicates a difference from a completion schedule time desired by the user 5 and the completion estimation time. The task No. 1 is estimated to be completed 51 minutes earlier than the completion schedule time (tomorrow 7:00 a.m.) of the task No. 1 illustrated in FIG. 4.

Further, the task No. 2 shows the values as follows: tomorrow 6:09 a.m. as a start time, tomorrow 9:03 a.m. as a completion estimation time, 2.7 GB/min as the lowest copy speed during a period of time from 6:09 a.m. to 7:12 a.m. tomorrow, 2.87 GB/min as an average copy speed, and 0.53 GB/min as an average decrease speed. Then, the task No. 2 is estimated to be completed 3 minutes late from the completion schedule time (tomorrow 9:00 a.m.) of the task No. 2 illustrated in FIG. 4.

Further, the task No. 3 shows the values as follows: tomorrow 6:09 a.m. as a start time, tomorrow 7:12 a.m. as a completion estimation time, 1.3 GB/min as the lowest copy speed during a period of time from 6:09 a.m. to 7:12 a.m. tomorrow, 1.3 GB/min as an average copy speed, and 0.3 GB/min as an average decrease speed. In addition, since the completion schedule time of the task No. 3 illustrated in FIG. 4 is not set, a difference between the completion schedule time and the completion estimation time of the task No. 3 is not shown.

For example, in a case where the completion estimation time is delayed behind the completion schedule time desired by the user 5, or in a case where the overlap degree exceeds an allowable value, the copy time estimating software 22 may inform the user 5 of an error through the display apparatus 80. In the example illustrated in FIG. 11, the copy time estimating software 22 informs the user 5 about that the completion estimation time of the task No. 2 is delayed behind the completion schedule time desired by the user 5. Further, the allowable value of the overlap degree is calculated for each overlap degree based on a history of estimation values obtained from the past copy time estimation process and actual measurement values obtained from the data copy process. In a case where the overlap degree exceeds the calculated allowable value, the copy time estimating software 22 may inform the user 5 of the fact that the accuracy in estimation is not assurable.

FIG. 12 is a diagram illustrating an overlap degree transition table in the storage system as the exemplary embodiment.

The overlap degree transition table 309 is a table showing a transition of the overlap degree of tasks in each time zone of the data copy processing plan, and created for each plan (task) based on the data copy processing capacity per unit time. The copy time estimating software 22 presents the overlap degree transition table 309 to the user 5 through the display apparatus 80.

In the example illustrated in FIG. 12, the overlap degree of tasks in time zones 9:00 p.m., 9:18 p.m., 10:00 p.m., tomorrow 2:54 a.m., and tomorrow 6:09 a.m. are shown. Each time zone excepting the start time and the completion time shows a time zone in which the overlap degree of tasks is changed. In other words, the overlap degree transition table 309 illustrated in FIG. 12 shows the values as follows: Housing overlap degree=1 in a time zone from 9:00 p.m. to 9:18 p.m., Overlap degree=0 in a time zone from 9:18 p.m. to 10:00 p.m., Housing overlap degree=1 and RAID group.Read.R Overlap degree=1 in a time zone from 10:00 p.m. to 2:54 a.m. tomorrow, and Overlap degree=0 in a time zone from 2:54 a.m. tomorrow to 6:09 a.m. tomorrow.

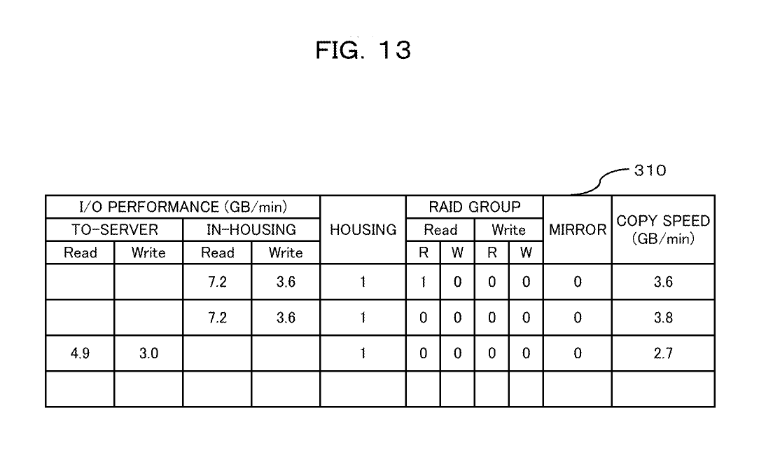

FIG. 13 is a diagram illustrating an actual overlap degree/copy speed table in the storage system as the exemplary embodiment.

The copy time estimating software 22 creates the actual overlap degree/copy speed table 310 in the data copy process, and calculates the influence degree using the created actual overlap degree/copy speed table 310. A method of calculating the influence degree using the actual overlap degree/copy speed table 310 will be described below using FIGS. 20 to 28.

In the example illustrated in FIG. 13, the I/O performance in the data copy process, the housing overlap degree, a RAID group overlap degree, a mirror overlap degree, and a copy speed are recorded in the actual overlap degree/copy speed table 310. The copy time estimating software 22 adds new data in the actual overlap degree/copy speed table 310 in a case where a predetermined time elapses or a case where the I/O performance, the housing overlap degree, the RAID group overlap degree, the mirror overlap degree, or the copy speed are changed. In the example illustrated in FIG. 13, only three pieces of data are shown for simplicity, but the embodiment is not limited thereto. The number of pieces of data recorded in the actual overlap degree/copy speed table 310 may be variously changed.

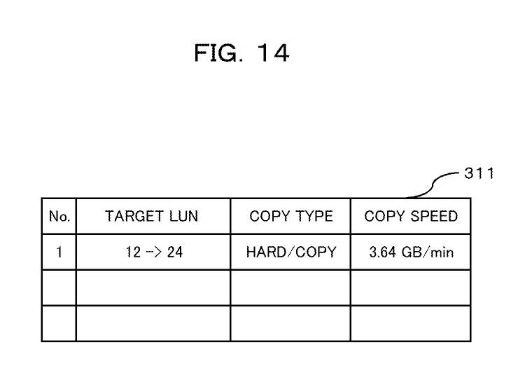

FIG. 14 is a diagram illustrating an advanced LUN table in the storage system as the exemplary embodiment.

The copy time estimating software 22 calculates a copy speed of the task based on an I/O advance in the data copy process, and creates the advanced LUN table 311. Then, the copy time estimating software 22 creates the actual overlap degree/copy speed table 310 illustrated in FIG. 13 using the advanced LUN table 311 thus created, and calculates the influence degree. A method of calculating the influence degree using the advanced LUN table 311 will be described using FIGS. 20 to 28.

In the example illustrated in FIG. 14, the task No. 1 corresponds to the task No. 1 illustrated in FIGS. 4, 5, 8, 9, and 11. The task No. 1 shows the values as follows: writing data read from the LUN 12 into the LUN 24, hard/copy, and 3.64 GB/min as a copy speed.

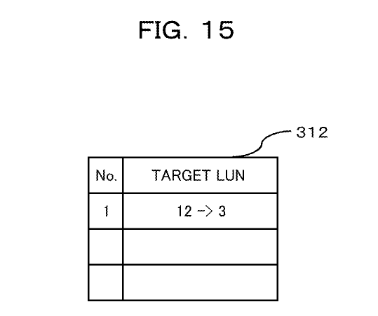

FIG. 15 is a diagram illustrating an another node session table in the storage system as the exemplary embodiment.

The copy time estimating software 22 makes communication with the copy time estimating software 22 of another node (another virtual server 111). Then, the copy time estimating software 22 creates the another node session table 312 which indicates information relating to the process which uses the same storage apparatus 2 as that of the data copy process of the own node during a currently running process. Further, the copy time estimating software 22 creates the actual overlap degree/copy speed table 310 illustrated in FIG. 13 using the created another node session table 312, and calculates the overlap degree.

The example illustrated in FIG. 15 shows that a process of writing the data read from the LUN 12 into the LUN 3 is in progress as the session of another node.

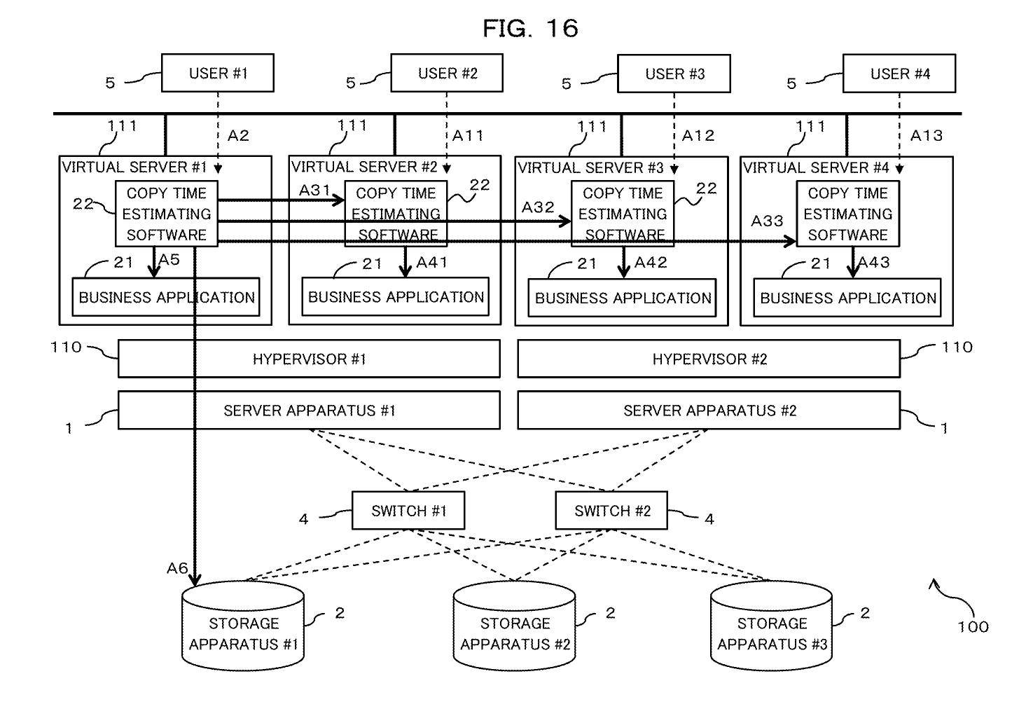

FIG. 16 is a diagram illustrating a copy time estimation process in the storage system as the exemplary embodiment.

The users #2 to #4 illustrated in FIG. 16 input the plan of the data copy process (the plan table 301) to the virtual servers #2 to #4 through the input apparatus 70, respectively (see Reference numerals A11 to A13).

In the example illustrated in FIG. 16, the user #1 wonders whether a backup process performed onto the storage apparatus #1 from at 11:00 p.m. could be completed before 6:00 a.m. tomorrow. Therefore, the user #1 instructs the virtual server #1 to perform the copy time estimation process (see Reference numeral A2). Specifically, the user #1 inputs the plan of the data copy process (the plan table 301) to the virtual server #1 through the input apparatus 70.

The copy time estimating software 22 of the virtual server #1 inquire a target LUN, a copy size, and a copy type from the copy time estimating software 22 of each of the virtual servers #2 to #4 (see Reference numerals A31 to A33).

The copy time estimating software 22 of each of the virtual servers #2 to #4 acquires the copy size and the copy type in the storage apparatus 2 of a plan target from the business applications 21 of the own node (see Reference numerals A41 to A43), and acquires the target LUN from the storage apparatus 2 of the plan target.

The copy time estimating software 22 of the virtual server #1 acquires the target LUN, the copy size, and the copy type transmitted from the copy time estimating software 22 of each of the virtual servers #2 to #4.

The copy time estimating software 22 of the virtual server #1 acquires the copy size and the copy type in the storage apparatus 2 of the plan target from the business application 21 of the own node (see Reference numeral A5).

The copy time estimating software 22 of the virtual server #1 acquires the target LUN of the plan of the data copy process, the task which is already instructed to the storage apparatus #1, and RAID group information from the storage apparatus #1 which is a target of the data copy process (see Reference numeral A6).

The copy time estimating software 22 of the virtual server #1 creates the plan LUN table 302 based on the plan table 301 which is input by the user #1, the copy size and the copy type which are acquired from the business application 21 of the own node, and the target LUN which is acquired from the storage apparatus #1. Further, the copy time estimating software 22 of the virtual server #1 creates the task table 303 based on the target LUN, the copy type, and the copy size which are acquired from another node. Furthermore, the copy time estimating software 22 of the virtual server #1 creates the RAID group table 304 based on the RAID group information which is acquired from the storage apparatus #1. Further, the copy time estimating software 22 of the virtual server #1 creates the plan/task total table 305 and the overlap degree table 306 based on the plan LUN table 302, the task table 303, and the RAID group table 304. Then, the copy time estimating software 22 of the virtual server #1 creates the estimation time table 308 and the overlap degree transition table 309 based on the overlap degree table 306 and the influence degree table 307 already stored, and presents the estimation time table 308 and the overlap degree transition table 309 to the user #1 through the display apparatus 80.

In other words, the copy time estimating software 22 of the virtual server #1 simulates the data copy process with reference to the plan of another node and the status of the storage apparatus 2, and calculates the completion estimation time. Then, the copy time estimating software 22 of the virtual server #1 presents to the user #1 the estimation time table 308 and the overlap degree transition table 309 showing time zones where the I/O processes from another node and the execution of the tasks are concentrated. Therefore, the user #1 can change the plan of the data copy process based on the estimation time table 308 and the overlap degree transition table 309 thus presented.

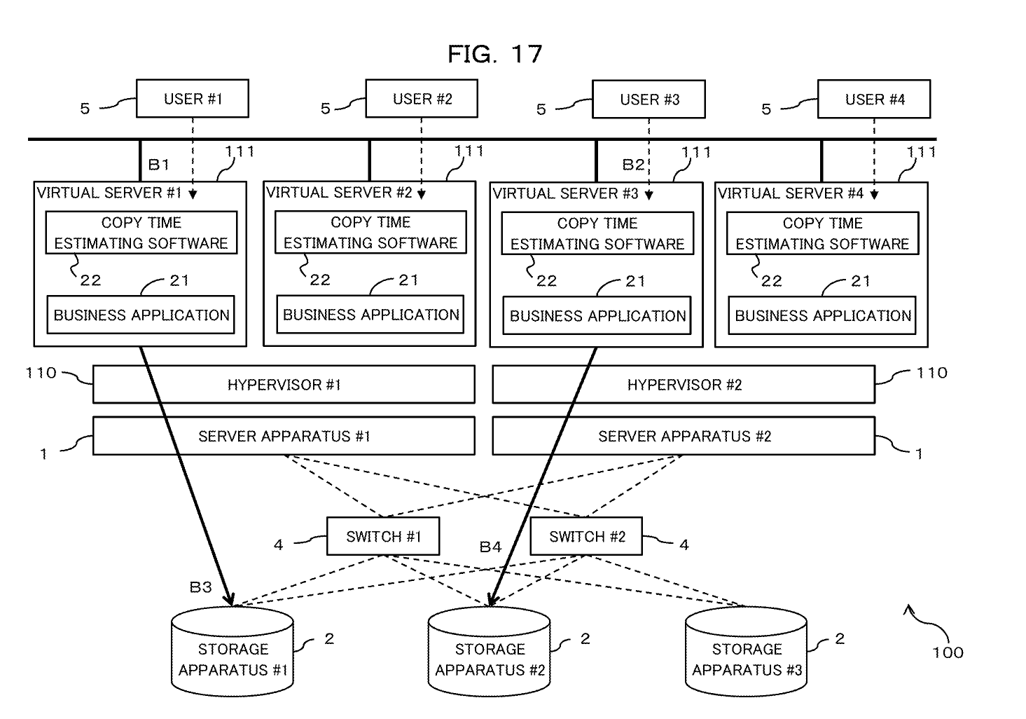

FIG. 17 is a diagram illustrating a data copy process in the storage system as the exemplary embodiment.

The users #1 and #3 illustrated in FIG. 17 instruct the execution of the data copy process to the virtual servers #1 and #3, respectively (see Reference numerals B1 and B2).

The business application 21 of the virtual server #1 writes the target data in the storage apparatus #1 and thus the data copy process starts (see Reference numeral B3).

The target data is written in the storage apparatus #2 and thus the data copy process starts (see Reference numeral B4).

Thus, the tasks instructed by the virtual servers #1 and #3 are written in the different storage apparatuses 2 (the storage apparatuses #1 and #2). Therefore, when the user #1 changes the plan based on the estimation time table 308 and the overlap degree transition table 309 presented by the copy time estimation process illustrated in FIG. 16, the data copy process in the virtual server #1 is executed while avoiding the time zones where the I/O processes from another node and the execution of the tasks are concentrated.

### [A-2] Program Configuration

FIG. 18 is a diagram schematically illustrating a program configuration in the storage system as the exemplary embodiment.

As illustrated in FIG. 18, the copy time estimating software 22 includes functions acting as an input module 221, a plan/task managing module 222, a time estimating module 223, an influence degree managing module 224, and an output module 225.

The input module 221 includes an interface through which the user 5 inputs a plan of the data copy process, and stores the input plan as the plan table 301 (see Reference numeral C1).

The plan/task managing module 222 receives an instruction to execute estimation from the user 5 (see Reference numeral C2), and collects information necessary for estimating a copy time from the input module 221, the copy time estimating software 22 of another node, the business application 21, and the storage apparatus 2. Specifically, the plan/task managing module 222 acquires the plan table 301 from the input module 221 (see Reference numeral C3). Further, the plan/task managing module 222 acquires a plan of another node from the copy time estimating software 22 of another node (see Reference numeral C4). The plan/task managing module 222 acquires information and the copy size of the target storage apparatus 2 from the business application 21 based on the plan table 301 (see Reference numeral C5). The plan/task managing module 222 acquires the target LUN, the task which is already instructed to the storage apparatus 2, and the RAID group information from the storage apparatus 2 (see Reference numeral C6). Furthermore, the plan/task managing module 222 creates the plan/task total table 305 based on the information acquired from the input module 221, the copy time estimating software 22 of another node, the business application 21, and the storage apparatus 2. Then, the plan/task managing module 222 inputs the created plan/task total table 305 into the time estimating module 223 (see Reference numeral C7).

The influence degree managing module 224 is a module which manages parameters of an equation for estimating a copy time as the influence degree table 307. The influence degree managing module 224 updates the influence degree table 307 based on an execution result of the data copy process (see Reference numeral C8), and inputs the updated influence degree table 307 into the time estimating module 223 (see Reference numeral C9).

The time estimating module 223 performs calculation to estimate the data copy processing time. The time estimating module 223 calculates the estimation time table 308 and the overlap degree transition table 309 based on the plan/task total table 305 and the influence degree table 307, and inputs the estimation time table 308 and the overlap degree transition table 309 into the output module 225 (see Reference numeral C10).

The output module 225 receives the estimation time table 308 and the overlap degree transition table 309, and presents the estimation time table 308 and the overlap degree transition table 309 to the user 5 (see Reference numeral C11).

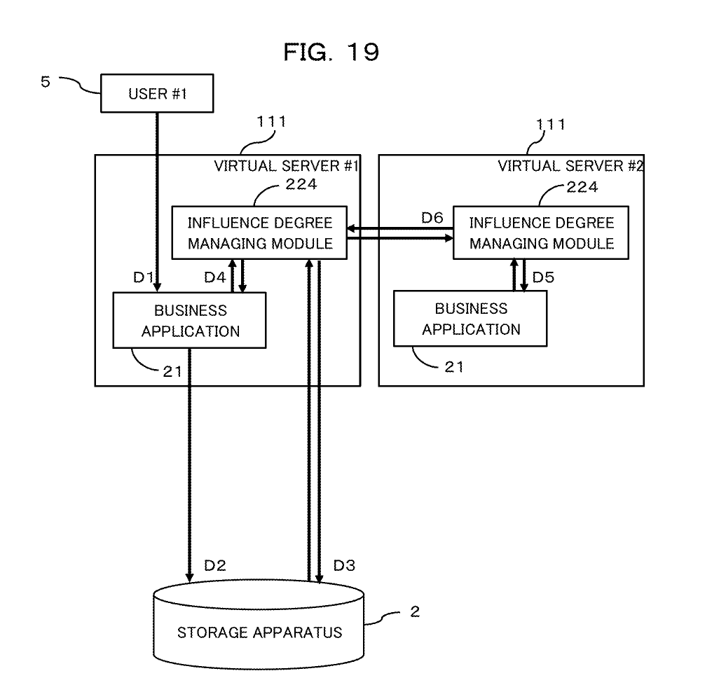

FIG. 19 is a diagram illustrating an influence degree management process in the storage system as the exemplary embodiment.

The user #1 illustrated in FIG. 19 also instructs the virtual server #1 to issue various I/O processes not included in the plan of the data copy process which is estimated by the copy time estimating software 22 (see Reference numeral D1). The business application 21 of the virtual server #1 issues an I/O process to the storage apparatus #1 based on the instruction from the user #1 (see Reference numeral D2).

In the exemplary embodiment, even a delay of the data copy process under the influence of the I/O process not included in the plan of the data copy process is reflected on the estimation time table 308 and the overlap degree transition table 309. In other words, the influence degree managing module 224 monitors the storage apparatus 2 and the business application 21 at all times, and corrects the parameters of the influence degree table 307. Specifically, the influence degree managing module 224 of the virtual server #1 acquires the task which is already instructed from the storage apparatus 2 (see Reference numeral D3). The influence degree managing module 224 of the virtual server #1 acquires information on the I/O process instructed by the user #1 from the business application 21 of the own node (see Reference numeral D4). Further, the influence degree managing module 224 of the virtual server #2 acquires information on the I/O process instructed by the user #2 (not illustrated in FIG. 19) from the business application 21 of the own node (see Reference numeral D5). Furthermore, the influence degree managing module 224 of the virtual server #1 acquires information on the I/O process instructed by the user #2 (not illustrated in FIG. 19) from the influence degree managing module 224 of the virtual server #2 (see Reference numeral D6). Then, the influence degree managing module 224 of the virtual server #1 updates the influence degree table 307 based on the task acquired from the storage apparatus 2 and the information on the I/O process acquired from the business application 21 of the own node and the influence degree managing module 224 of the virtual server #2.

### [A-3] Specific Example of Influence Degree Update Process

Hereinafter, a specific example of the influence degree update process performed in the storage system 100 as the exemplary embodiment will be described with reference to FIGS. 20 to 28.

The user 5, for example, inputs a command indicating the following disk exchange to the business application 21 of the virtual server 111 through the input apparatus 70.

Command: sdxyswap -I -c class2-d disk10

In addition, the I/O process related to the input command may have no relation with the plan of the data copy process, and may be directly issued to the storage apparatus 2 without passing through the business application 21.

FIG. 20 is a diagram illustrating an advanced LUN table used in the influence degree update process in the storage system as the exemplary embodiment.

The influence degree managing module 224 acquires the status of the business application 21 in a periodic manner (for example, every 1 minute), and acquires the information of the I/O advance and the information on the target storage apparatus 2. Then, the influence degree managing module 224 calculates the copy speed from the I/O advance, and creates the advanced LUN table 311 illustrated in FIG. 20. In addition, since the format of the advanced LUN table 311 illustrated in FIG. 20 is the same as that of the advanced LUN table 311 illustrated in FIG. 14, the description thereof will not be repeated.

The influence degree managing module 224 makes communication with the storage apparatus 2, acquires the target LUN and the copy speed of the task performed in the storage apparatus 2, and adds the target LUN and the copy speed to the advanced LUN table 311. Herein, the task is excluded from the description for simplicity.

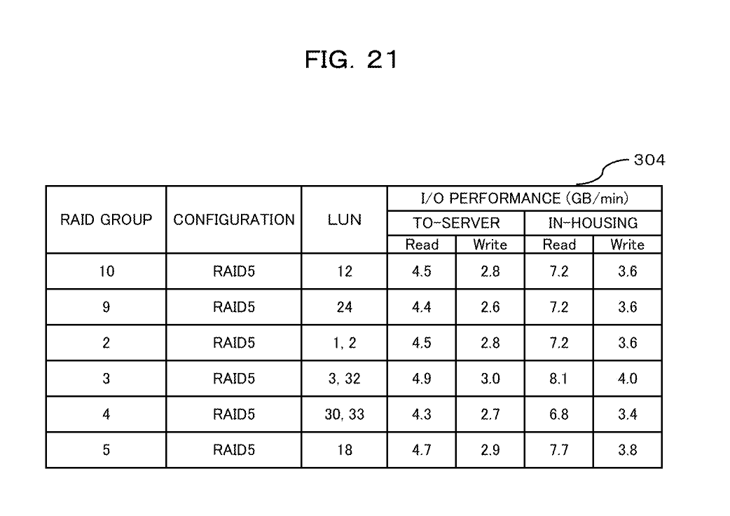

FIG. 21 is a diagram illustrating a RAID group table used in the influence degree update process in the storage system as the exemplary embodiment.

The influence degree managing module 224 acquires the RAID group table 304 illustrated in FIG. 21 from the storage apparatus 2. In addition, since the format of the RAID group table 304 illustrated in FIG. 21 is the same as that of the RAID group table 304 illustrated in FIG. 7, the description thereof will not be repeated.

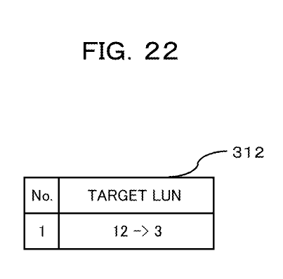

FIG. 22 is a diagram illustrating an another node session table used in the influence degree update process in the storage system as the exemplary embodiment.

The influence degree managing module 224 makes communication with the copy time estimating software 22 of another node, acquires information relating to the process which uses the same storage apparatus 2 as that of the process of the own node during a currently running process, and creates the another node session table 312 illustrated in FIG. 22. In addition, the format of the another node session table 312 illustrated in FIG. 22 is the same as that of the another node session table 312 illustrated in FIG. 15, the description thereof will not be repeated.

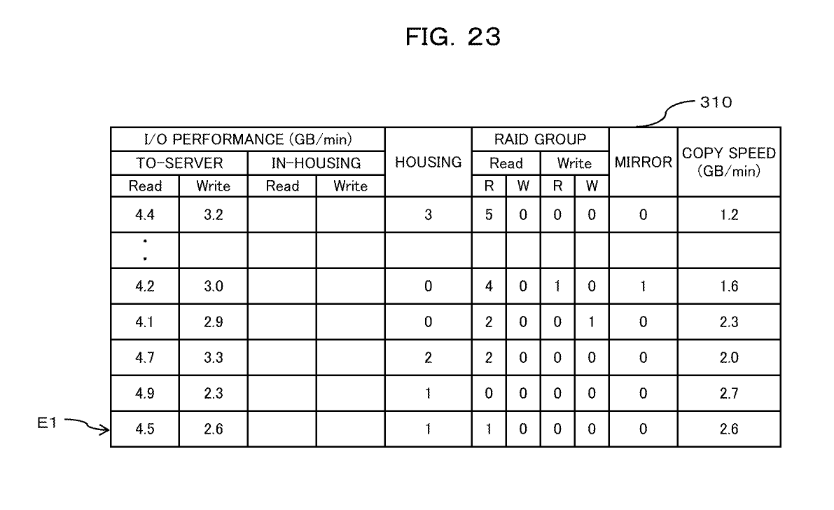

FIG. 23 is a diagram illustrating a first example of the actual overlap degree/copy speed table used in the influence degree update process in the storage system as the exemplary embodiment.

The influence degree managing module 224 calculates the overlap degree of the I/O process related to the command which is input by the user 5 based on the advanced LUN table 311, the RAID group table 304, and the another node session table 312 respectively illustrated in FIGS. 20 to 22. Then, the influence degree managing module 224 adds the I/O performance value, the overlap degree, and the copy speed of the task No. 1 illustrated in FIG. 20 to the actual overlap degree/copy speed table 310 illustrated in FIG. 23 (see Reference numeral E1). In the example denoted by Reference numeral E1 in FIG. 23, the read performance and the write performance on the server apparatus 1 are 4.5 GB/min and 2.6 GB/min respectively, and the housing overlap degree is 1, the RAID group.Read.R Overlap degree is 1, and the copy speed is 2.6 GB/min.

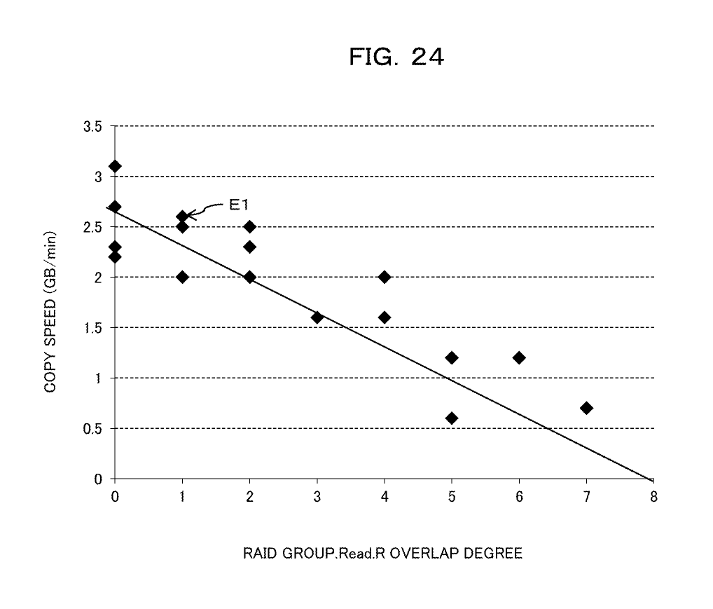

FIG. 24 is a diagram illustrating a first example of a relation between an overlap degree and a copy speed in the storage system as the exemplary embodiment.

The influence degree managing module 224 performs a regression analysis on data denoted by Reference numeral E1 in FIG. 23, and calculates the influence degree. The regression analysis is a multiple regression using 11-dimensional variables (an explanatory variable is 10-dimensional).

Hereinafter, it is assumed that the regression analysis using 2-dimensional variables, that is, the RAID group.Read.R Overlap degree and the copy speed is performed in the example illustrated in FIGS. 24, 26, and 28.

The plot denoted by Reference numeral E1 in FIG. 24 corresponds to a relation between the RAID group.Read.R Overlap degree and the copy speed of the data denoted by Reference numeral E1 in FIG. 23. In other words, the plot denoted by Reference numeral E1 in FIG. 24 is positioned at coordinates (RAID group.Read.R Overlap degree, Copy speed)=(1, 2.6). Then, as illustrated in FIG. 24, a regression line is determined based on a plurality of plots. The influence degree managing module 224 sets a value obtained by multiplying a slope of the regression line illustrated in FIG. 24 by −1 as the RAID group.Read.R Overlap degree, and updates the influence degree table 307 illustrated in FIG. 10.

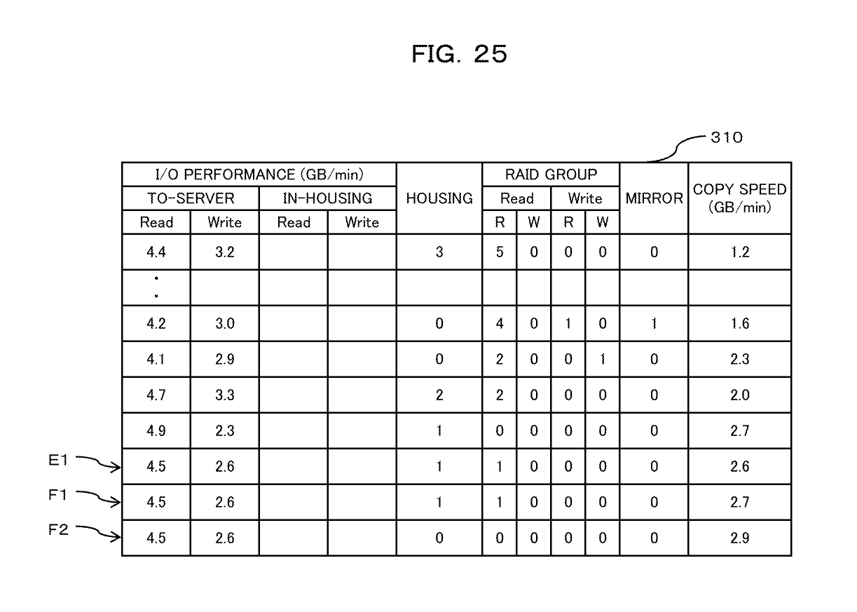

FIG. 25 is a diagram illustrating a second example of the actual overlap degree/copy speed table used in the influence degree update process in the storage system as the exemplary embodiment.

The influence degree managing module 224 updates the advanced LUN table 311, the RAID group table 304, and the another node session table 312 respectively illustrated in FIGS. 20 to 22, after a predetermined period of time (for example, after 1 minute) since the status of the previous business application 21 is acquired. Then, the influence degree managing module 224 updates the actual overlap degree/copy speed table 310 based on the updated tables (the advanced LUN table 311, the RAID group table 304, and the another node session table 312).

As illustrated in FIG. 25, in addition to the data denoted by Reference numeral E1 in FIG. 23, the influence degree managing module 224 adds two pieces of data in the actual overlap degree/copy speed table 310 (see Reference numerals F1 and F2). In the example denoted by Reference numeral F1 in FIG. 25, the RAID group.Read.R is 1 and the copy speed is 2.7 GB/min, and in the example denoted by Reference numeral F2, the RAID group.Read.R is 0 and the copy speed is 2.9 GB/min.

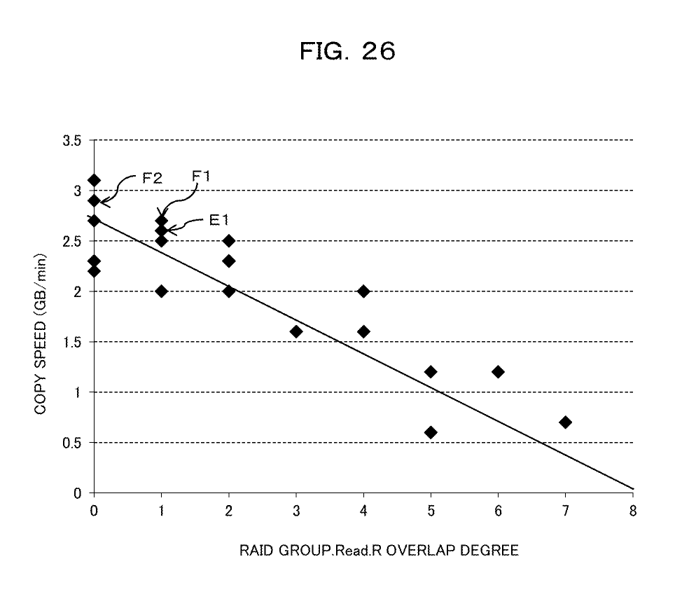

FIG. 26 is a diagram illustrating a second example of a relation between an influence degree and a copy speed in the storage system as the exemplary embodiment.

In the example illustrated in FIG. 26, the plots denoted by Reference numerals F1 and F2 are illustrated in addition to the plot denoted by Reference numeral E1 in FIG. 24. The plots denoted by Reference numerals F1 and F2 in FIG. 26 correspond to a relation between the RAID group.Read.R Overlap degrees and the copy speeds of the data denoted by Reference numerals F1 and F2 in FIG. 25, respectively. In other words, the plots denoted by Reference numerals F1 and F2 in FIG. 26 are positioned at coordinates (RAID group.Read.R Overlap degree, Copy speed)=(1, 2.7), (0, 2.9) respectively. Then, as illustrated in FIG. 26, the regression line is updated based on a plurality of plots. The influence degree managing module 224 sets a value obtained by multiplying the slop of the regression line illustrated in FIG. 26 by −1 as the RAID group.Read.R Overlap degree, and updates the influence degree table 307 illustrated in FIG. 10.

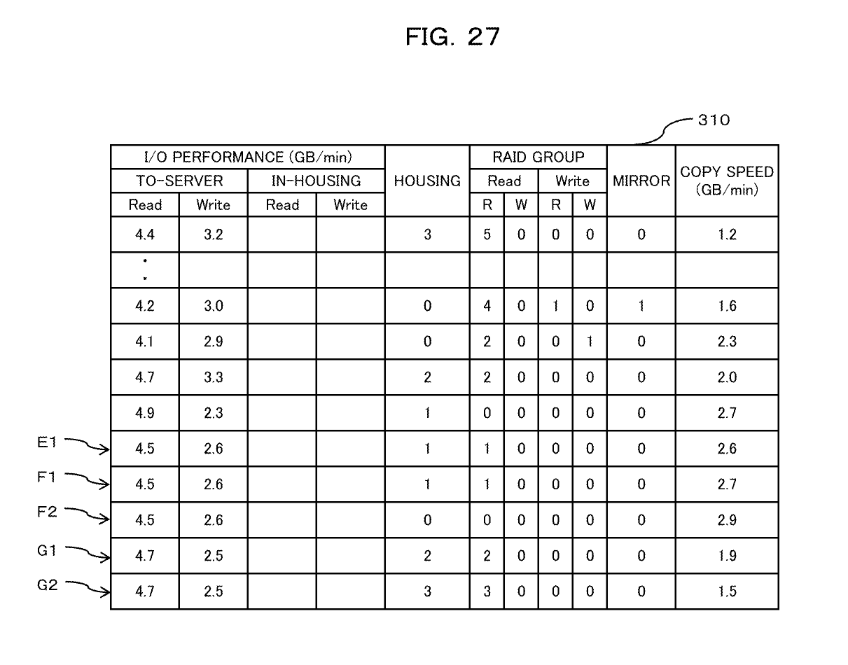

FIG. 27 is a diagram illustrating a third example of the actual overlap degree/copy speed table used in the influence degree update process in the storage system as the exemplary embodiment.

The influence degree managing module 224 updates the advanced LUN table 311, the RAID group table 304, and the another node session table 312 respectively illustrated in FIGS. 20 to 22 further after a predetermined period of time (for example, after 1 minute) since the status of the previous business application 21 is acquired. Then, the influence degree managing module 224 updates the actual overlap degree/copy speed table 310 based on the updated tables (the advanced LUN table 311, the RAID group table 304, and the another node session table 312).

As illustrated in FIG. 27, in addition to the data denoted by Reference numerals E1, F1, and F2 in FIG. 25, the influence degree managing module 224 adds two pieces of data in the actual overlap degree/copy speed table 310 (see Reference numerals G1 and G2). In the example denoted by Reference numeral G1 in FIG. 27, the RAID group.Read.R is 2 and the copy speed is 1.9 GB/min, and in the example denoted by Reference numeral G2, the RAID group.Read.R is 3 and the copy speed is 1.5 GB/min.

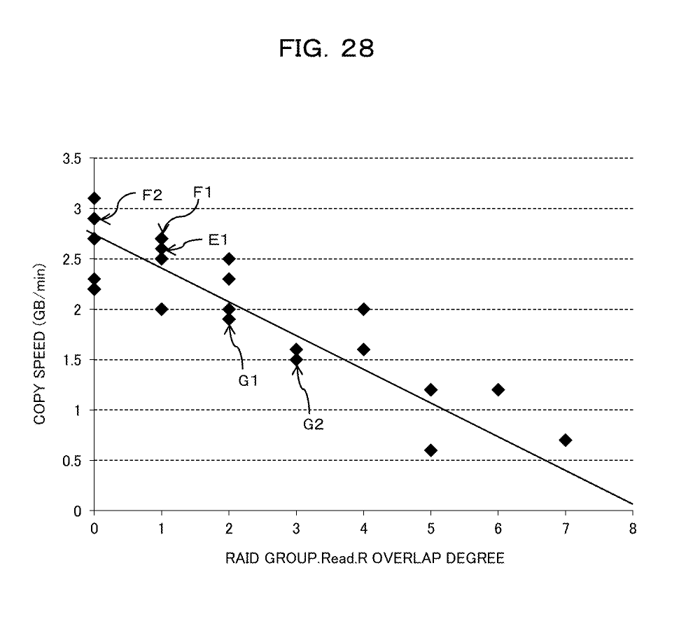

FIG. 28 is a diagram illustrating a third example of a relation between an influence degree and a copy speed in the storage system as the exemplary embodiment.

In the example illustrated in FIG. 28, the plots denoted by Reference numerals G1 and G2 are illustrated in addition to the plots denoted by Reference numerals E1, F1, and F2 in FIG. 26. The plots denoted by Reference numerals G1 and G2 in FIG. 28 correspond to a relation between the RAID group.Read.R Overlap degrees and the copy speeds of the data denoted by Reference numerals G1 and G2 in FIG. 27, respectively. In other words, the plots denoted by Reference numerals G1 and G2 in FIG. 28 are positioned at coordinates (RAID group.Read.R Overlap degree, Copy speed)=(2, 1.9), (3, 1.5) respectively. Then, as illustrated in FIG. 28, the regression line is updated based on a plurality of plots. The influence degree managing module 224 sets a value obtained by multiplying the slop of the regression line illustrated in FIG. 28 by −1 as the RAID group.Read.R Overlap degree, and updates the influence degree table 307 illustrated in FIG. 10.

Hereinafter, the influence degree managing module 224 repeatedly updates the influence degree table 307 every predetermined period of time (for example, every 1 minute).

### [A-4] Operations

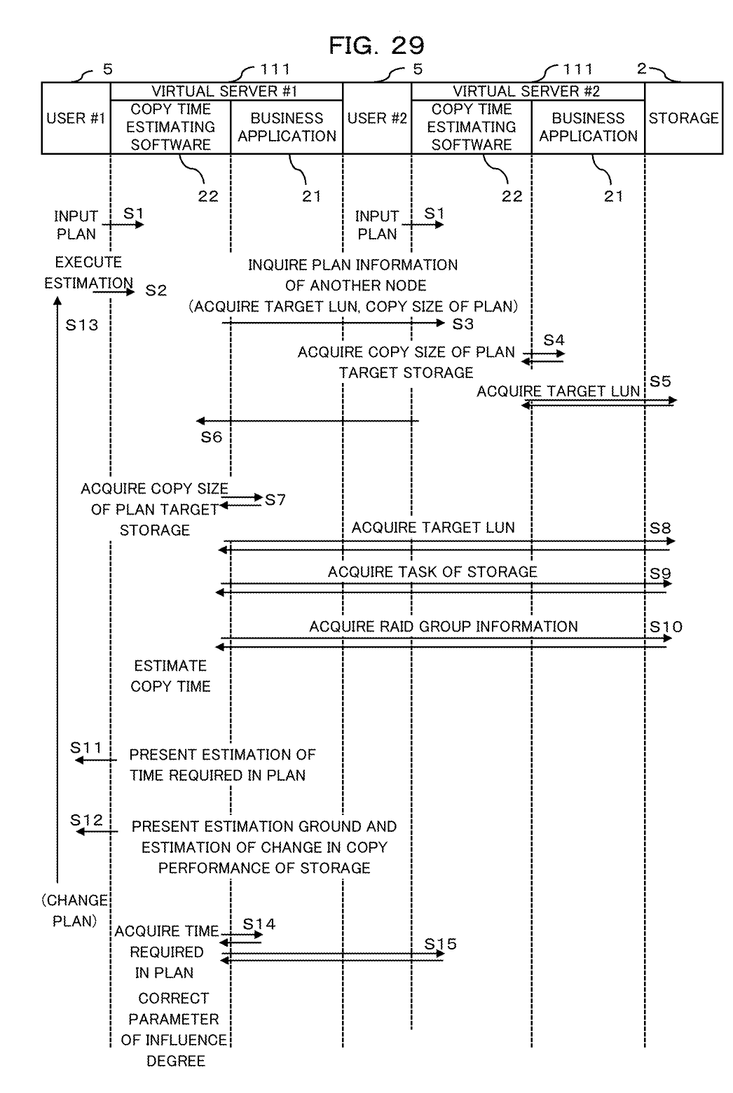

The copy time estimation process in the storage system as the exemplary embodiment configured as described above will be described according to a sequence diagram illustrated in FIG. 29 (Steps S1 to S15).

In the example illustrated in FIG. 29, the storage system 100 includes one or plural server apparatuses 1 and one storage apparatus 2, and the one or plural server apparatuses 1 functions as the virtual server #1 and the virtual server #2. Further, the users #1 and #2 instruct the virtual servers #1 and #2 to issue the I/O processes, respectively.

The users #1 and #2 input the plan of the data copy process to the copy time estimating software 22 of the virtual servers #1 and #2, respectively (Step S1).

The user #1 instructs the copy time estimating software 22 of the virtual server #1 to execute the copy time estimation process (Step S2).

The copy time estimating software 22 of the virtual server #1 inquires the plan information of another node (Step S3). Specifically, the copy time estimating software 22 of the virtual server #1 inquires the target LUN and the copy size of the plan from the copy time estimating software 22 of the virtual server #2.

The copy time estimating software 22 of the virtual server #2 acquires the copy size in the storage apparatus 2 of the plan target from the business application 21 of the own node (Step S4).

The copy time estimating software 22 of the virtual server #2 acquires the target LUN from the storage apparatus 2 (Step S5).

The copy time estimating software 22 of the virtual server #1 acquires the target LUN and the copy size of the plan transmitted by the copy time estimating software 22 of the virtual server #2 (Step S6).

The copy time estimating software 22 of the virtual server #1 acquires the copy size in the storage apparatus 2 of the plan target from the business application 21 of the own node (Step S7).

The copy time estimating software 22 of the virtual server #1 acquires the target LUN, the task which is already instructed to the storage apparatus 2, and the RAID group information from the storage apparatus 2 (Steps S8 to S10), and estimates a copy time.

The copy time estimating software 22 of the virtual server #1 creates the estimation time table 308, and presents the estimation of a time required in the plan to the user #1 (Step S11). In other words, the copy time estimating software 22 estimates the copy time based on the plan of the data copy process input by each user 5 and the information acquired from the business application 21 and the storage apparatus 2. Then, the copy time estimating software 22 presents the estimated copy time to the user 5 who instructs the execution of the copy time estimation process.

The copy time estimating software 22 of the virtual server #1 creates the overlap degree transition table 309, and presents an estimation ground and an estimation of change in copy performance of the storage apparatus 2 to the user #1 (Step S12).

In a case where there is a need to change the plan, the procedure returns to Step S2 (Step S13). In other words, the copy time estimating software 22 estimates a copy time again, and presents the estimated copy time to the user 5.

On the other hand, in a case where there is no need to change in the plan, the user #1 instructs the execution of the plan of the data copy process to the business application 21 of the virtual server #1.

The copy time estimating software 22 of the virtual server #1 acquires a required time for the plan from the business application 21 of the own node and the copy time estimating software 22 of the virtual server #2 (Steps S14 and S15), and corrects the parameters of the influence degree table 307.

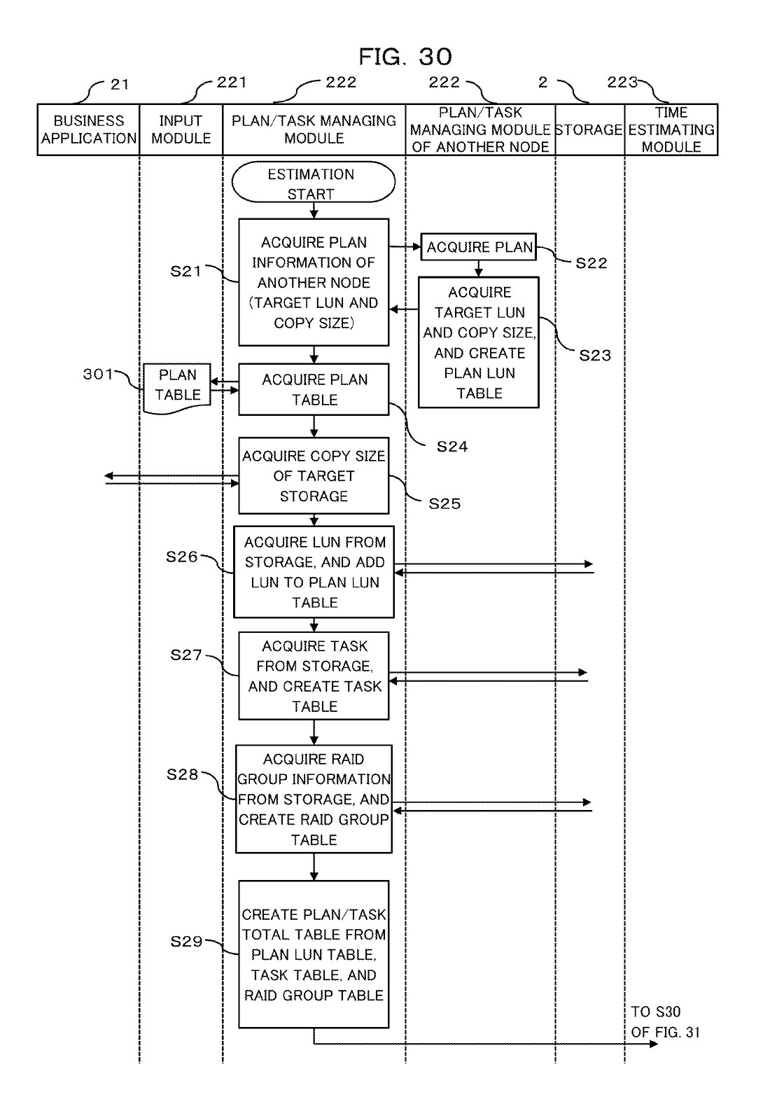

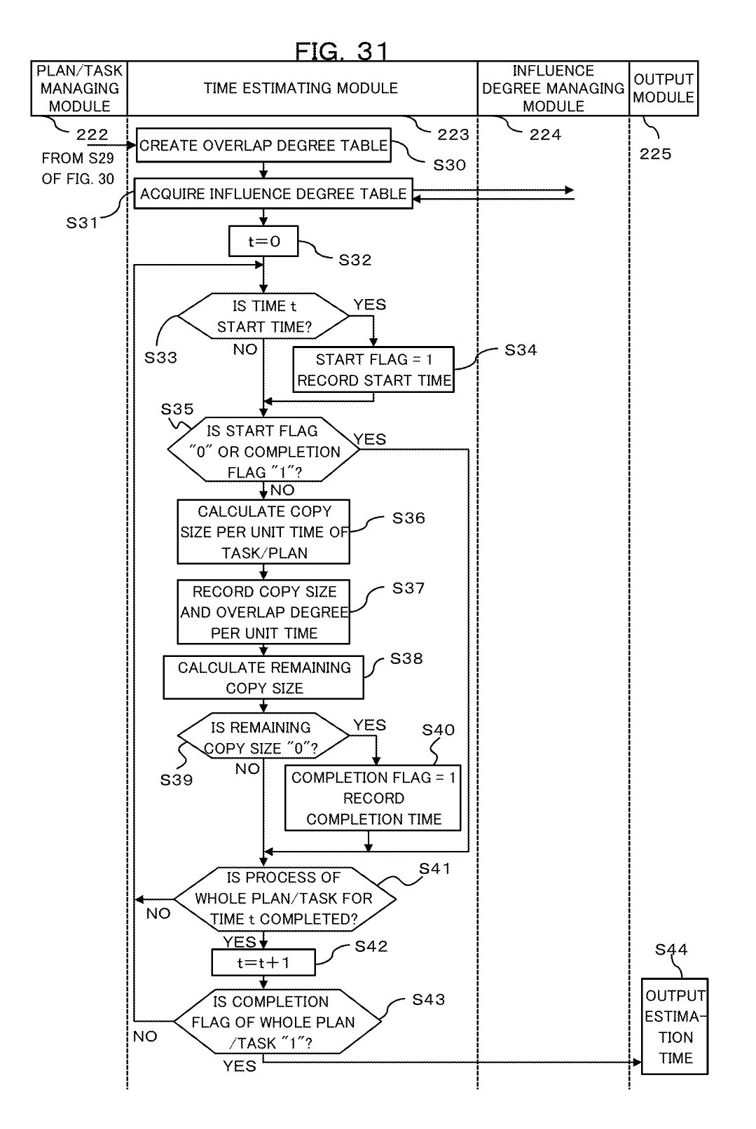

Next, the copy time estimation process in the storage system as the exemplary embodiment will be described in detail according to flowcharts illustrated in FIGS. 30 and 31 (Steps S21 to S44). The flowchart of FIG. 30 illustrates the process of Steps S21 to S29, and the flowchart of FIG. 31 illustrates the process of Steps S30 to S44.

The user 5 instructs the virtual server 111 to execute the copy time estimation process.

The plan/task managing module 222 acquires the plan information of another node (Step S21 of FIG. 30). Specifically, the plan/task managing module 222 acquires the target LUN and the copy size from the plan/task managing module 222 of another node.

The plan/task managing module 222 of another node acquires the plan table 301 which is input by the user 5 (Step S22 of FIG. 30).

The plan/task managing module 222 acquires the target LUN and the copy size from the storage apparatus 2 and the business application 21, respectively, and creates the plan LUN table 302 (Step S23 of FIG. 30). Then, the plan/task managing module 222 of another node transmits the target LUN and the copy size thus acquired to the plan/task managing module 222 of the inquiry source node.

The plan/task managing module 222 acquires the plan table 301 which is input by the user 5 (Step S24 of FIG. 30).

The plan/task managing module 222 acquires the copy size of the storage apparatus 2 which is a plan target from the business application 21 (Step S25 of FIG. 30).

The plan/task managing module 222 acquires the target LUN from the storage apparatus 2, and adds the target LUN to the plan LUN table 302 (Step S26 of FIG. 30).

The plan/task managing module 222 acquires the already instructed task from the storage apparatus 2, and creates the task table 303 (Step S27 of FIG. 30).

The plan/task managing module 222 acquires the RAID group information from the storage apparatus 2, and creates the RAID group table 304 (Step S28 of FIG. 30).

The plan/task managing module 222 creates the plan/task total table 305 based on the plan LUN table 302, the task table 303, and the RAID group table 304 thus created (Step S29 of FIG. 30).

The time estimating module 223 creates the overlap degree table 306 (Step S30 of FIG. 31).

The time estimating module 223 acquires the influence degree table 307 from the influence degree managing module 224 (Step S31 of FIG. 31).

The time estimating module 223 sets time to 0 (t=0) (Step S32 of FIG. 31).

The time estimating module 223 determines whether time t is the start time (t=0) (Step S33 of FIG. 31).

In a case where time t is the start time (t=0) (see YES route in Step S33 of FIG. 31), the time estimating module 223 sets a start flag to 1. For example, the time estimating module 223 records the start time in the RAM 50 (Step S34 of FIG. 31), the procedure proceeds to Step S35 of FIG. 31.

In a case where time t is not the start time (t=0) (see NO route in Step S33 of FIG. 31), the time estimating module 223 determines whether the start flag is 0 or a completion flag is 1 (Step S35 of FIG. 31).

In a case where the start flag is 0 or the completion flag is 1 (see YES route in Step S35 of FIG. 31), the procedure proceeds to Step S41 of FIG. 31.

In a case where the start flag is not 0 and the completion flag is not 1 (see NO route in Step S35 of FIG. 31), the time estimating module 223 calculates the copy size per unit time of the task (plan) (Step S36 of FIG. 31).

The time estimating module 223 records the copy size per unit time and the overlap degree thus calculated in the RAM 50 for example (Step S37 of FIG. 31).

The time estimating module 223 calculates a remaining copy size of the task (plan) of which the copy size per unit time is calculated (Step S38 of FIG. 31).

The time estimating module 223 determines whether the remaining copy size thus calculated is 0 (Step S39 of FIG. 31).

In a case where the remaining copy size thus calculated is 0 (see YES route in Step S39 of FIG. 31), the time estimating module 223 records the completion flag as 1 and records the completion time in the RAM 50 for example (Step S40 of FIG. 31), and then the procedure proceeds to Step S41.

On the other hand, in a case where the remaining copy size thus calculated is not 0 (see NO route in Step S39 of FIG. 31), the time estimating module 223 determines whether the process of the whole task (plan) for time t is completed (Step S41 of FIG. 31).

In a case where the process of the whole task (plan) for time t is not completed (see NO route in Step S41 of FIG. 31), the procedure proceeds to the process of the next task (plan) and returns to Step S33 of FIG. 31.

On the other hand, in a case where the process of the whole task (plan) for time t is completed (see YES route in Step S41 of FIG. 31), the time estimating module 223 increases time t (see Step S42 of FIG. 31).

The time estimating module 223 determines whether the completion flag of the whole task (plan) is 1 (Step S43 of FIG. 31).

In a case where the completion flag of the whole task (plan) is not 1 (see NO route in Step S43 of FIG. 31), the procedure returns to Step S33.

On the other hand, in a case where the completion flag of the whole task (plan) is 1 (see YES route in Step S43 of FIG. 31), the time estimating module 223 creates the estimation time table 308 and the overlap degree transition table 309. The time estimating module 223 integrates the calculated copy size of the task (plan) which is executed per unit time to calculate the estimation time of each task (plan).

Then, the output module 225 presents the estimation time table 308 and the overlap degree transition table 309 thus created to the user 5 through the display apparatus 80 (Step S44 of FIG. 31), and the process is ended.

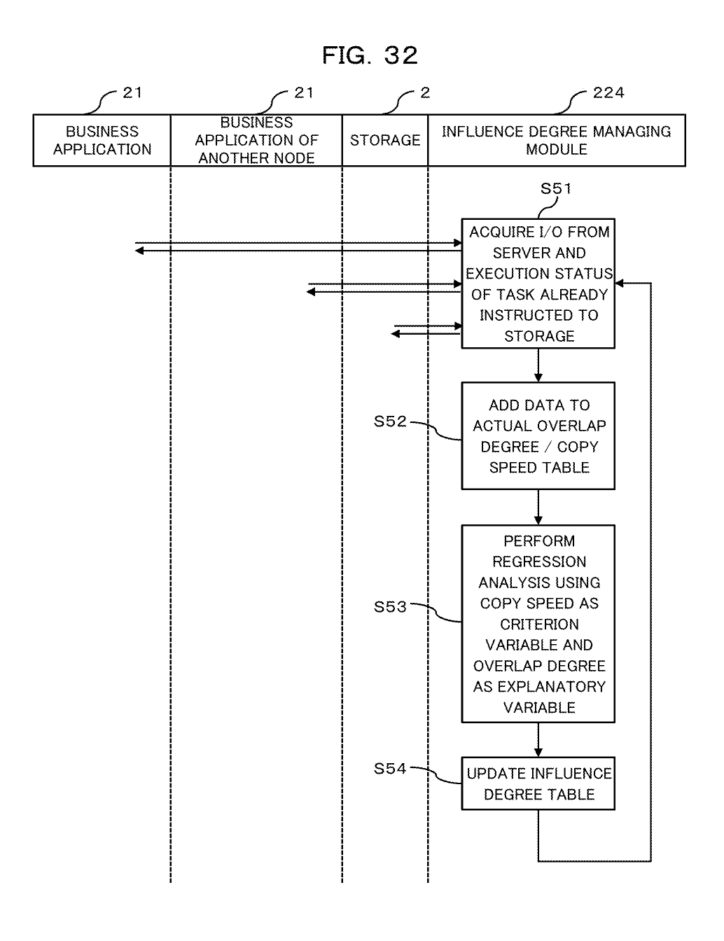

Next, the influence degree update process in the storage system as the exemplary embodiment will be described according to a flowchart illustrated in FIG. 32 (Steps S51 to S54).

The influence degree managing module 224 acquires the I/O processes performed by the virtual servers 111 (the server apparatuses 1) from the business applications 21 of the own node and another node, and acquires the execution status of the task already instructed to the storage apparatus 2 from the storage apparatus 2 (Step S51).

The influence degree managing module 224 adds the I/O process and the execution status of the task thus acquired to the actual overlap degree/copy speed table 310 (Step S52).

The influence degree managing module 224 performs the regression analysis using the copy speed in the actual overlap degree/copy speed table 310 as a criterion variable (a dependent variable) and the overlap degree as an explanatory variable (an independent variable) as illustrated in FIGS. 24, 26, and 28 (Step S53).

The influence degree managing module 224 sets a value obtained by multiplying a slop of the regression line found through the regression analysis by −1 as a new influence value, and updates the influence degree table 307 (Step S54). The procedure returns to Step S51.

In addition, the influence degree managing module 224 may perform the information acquisition in Step S51 and the update of the influence degree table 307 in Step S54 at a different frequency.

### [A-5] Advantages

As described above, according to the server apparatus (the information processing apparatus) 1 in the exemplary embodiment, it is possible to obtain an advantage that the data copy completion estimation time is calculated with a high accuracy.

Specifically, the overlap degree estimation information creating unit 11 creates the overlap degree estimation information 306 indicating the overlap degrees which are estimated for the tasks executed in the storage apparatus 2 by the information processing apparatus 1 of the own node and the information processing apparatus 1 of another node. Therefore, it is possible to calculate the overlap degree of tasks, which is generated by a task executed by the information processing apparatus 1 of another node as well as the information processing apparatus 1 of the own node.

The influence degree estimation information creating unit 12 creates the influence degree estimation information 307 indicating the influence degree on the performance of the storage apparatus 2 in which the overlapping of the tasks is estimated to occur. Therefore, it is possible to calculate the data copy completion estimation time 308 to which the influence degrees caused by an I/O process and a task having no relation with the plan of the data copy process are also added.

The completion estimation time calculating unit 13 calculates the data copy completion estimation time 308 based on the overlap degree estimation information 306 and the influence degree estimation information 307. Therefore, the user 5 can ascertain the data copy completion estimation time 308 and change the plan before executing the plan of the data copy process, so that an actual completion time of the data copy process is not delayed behind a data copy schedule time desired by the user 5.

The completion estimation time calculating unit 13 calculates the data copy processing capacity per unit time based on the overlap degree and the performance value, each of which is weighted by the influence degree, and thus calculates the data copy completion estimation time 308. Therefore, it is possible to calculate the data copy completion estimation time 308 to which the influence degrees caused by an I/O process and a task having no relation with the plan of the data copy process are also added. Accordingly, an actual completion time of the data copy process is not delayed behind a data copy schedule time desired by the user 5.

The overlap degree transition information creating unit 17 creates the overlap degree transition information 309 indicating a transition of the overlap degree of tasks in each time zone of the plan 301 based on the data copy processing capacity per unit time calculated by the completion estimation time calculating unit 13. Therefore, the user 5 can ascertain the overlap degree of the tasks in each time zone and change the plan before executing the plan of the data copy process, so that it is possible to prevent a specific storage apparatus 2 (the RAID group) from being applied with the load due to the overlapping of the tasks.

That is, according to the exemplary embodiment, even in a case where a number of tasks are requested from the server apparatus 1 to the storage apparatus 2 and in a case where there are a lot of the server apparatuses 1 and the storage apparatuses 2, the user 5 can ascertain a required time for the data copy process and can efficiently create a business plan.

### [B] Others

The disclosed technology is not limited to the above-mentioned embodiment, and various modifications can be made in a scope not departing from the spirit of the embodiment. The respective configurations and the respective processes of the embodiment can be optionally selected if needed, or may be appropriately combined with each other.

According to the disclosed information processing apparatus, it is possible to calculate the data copy completion estimation time with a high accuracy.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An information processing apparatus which shares a storage apparatus with another information processing apparatus, the information processing apparatus comprising:
an overlap degree estimation information creating unit that creates overlap degree estimation information indicating an estimated overlap degree of tasks which are executed in the storage apparatus by the information processing apparatus and the other information processing apparatus;
an influence degree estimation information creating unit that creates influence degree estimation information indicating an influence degree on a performance of the storage apparatus in which an overlapping of the tasks is estimated to occur; and
a completion estimation time calculating unit that calculates a data copy completion estimation time based on the overlap degree estimation information and the influence degree estimation information.

2. The information processing apparatus according to claim 1, further comprising:
a plan information creating unit that creates plan information in association with a plan of a data copy process and a logical address of the storage apparatus related to the plan, the data copy process being executed on the storage apparatus by the information processing apparatus and the other information processing apparatus;
a task information creating unit that creates task information which indicates a task to be executed by the storage apparatus; and
a RAID (redundant arrays of independent disks) group information creating unit that creates RAID group information which indicates a logical address and a performance value of each RAID group defined in the storage apparatus,
wherein the overlap degree estimation information creating unit creates the overlap degree estimation information based on the plan information, the task information, and the RAID group information.

3. The information processing apparatus according to claim 2, wherein
the completion estimation time calculating unit calculates a data copy processing capacity per unit time based on the overlap degree and the performance value, each of which is weighted by the influence degree, so as to calculate the data copy completion estimation time.

4. The information processing apparatus according to claim 3, further comprising:
an overlap degree transition information creating unit that creates overlap degree transition information which indicates a transition of an overlap degree of tasks in each time zone of the plan based on the data copy processing capacity per unit time calculated by the completion estimation time calculating unit.

5. The information processing apparatus according to claim 1, wherein
the overlap degree estimation information creating unit creates the overlap degree estimation information based on an overlap degree between a writing operation and a reading operation in the same RAID group.

6. A data copy processing management method which is performed in an information processing apparatus sharing a storage apparatus with another information processing apparatus, the method comprising:
creating overlap degree estimation information indicating an estimated overlap degree of tasks which are executed in the storage apparatus by the information processing apparatus and the other information processing apparatus;
creating influence degree estimation information indicating an influence degree on a performance of the storage apparatus in which an overlapping of the tasks is estimated to occur; and
calculating a data copy completion estimation time based on the overlap degree estimation information and the influence degree estimation information.

7. The data copy processing management method according to claim 6, further comprising:
creating plan information in association with a plan of a data copy process and a logical address of the storage apparatus related to the plan, the data copy process being executed on the storage apparatus by the information processing apparatus and the other information processing apparatus;
creating task information which indicates a task to be executed by the storage apparatus;
creating RAID (redundant arrays of independent disks) group information which indicates a logical address and a performance value of each RAID group defined in the storage apparatus; and
creating the overlap degree estimation information based on the plan information, the task information, and the RAID group information.

8. The data copy processing management method according to claim 7, wherein
a data copy processing capacity per unit time is calculated based on the overlap degree and the performance value, each of which is weighted by the influence degree, so as to calculate the data copy completion estimation time.

9. The data copy processing management method according to claim 8, further comprising:
creating overlap degree transition information which indicates a transition of an overlap degree of tasks in each time zone of the plan based on the calculated data copy processing capacity per unit time.

10. The data copy processing management method according to claim 6, wherein
the overlap degree estimation information is created based on an overlap degree between a writing operation and a reading operation in the same RAID group.

11. A non-transitory computer-readable recording medium having stored therein a data copy processing management program for causing a computer included in an information processing apparatus sharing a storage apparatus with another information processing apparatus to execute a process comprising:
creating overlap degree estimation information indicating an estimated overlap degree of tasks which are executed in the storage apparatus by the information processing apparatus and the other information processing apparatus;
creating influence degree estimation information indicating an influence degree on a performance of the storage apparatus in which an overlapping of the tasks is estimated to occur; and
calculating a data copy completion estimation time based on the overlap degree estimation information and the influence degree estimation information.

12. The non-transitory computer-readable recording medium having stored therein the data copy processing management program according to claim 11, to execute the process further comprising:
creating plan information in association with a plan of a data copy process and a logical address of the storage apparatus related to the plan, the data copy process being executed on the storage apparatus by the information processing apparatus and the other information processing apparatus;
creating task information which indicates a task to be executed by the storage apparatus;
creating RAID (redundant arrays of independent disks) group information which indicates a logical address and a performance value of each RAID group defined in the storage apparatus; and
creating the overlap degree estimation information based on the plan information, the task information, and the RAID group information.

13. The non-transitory computer-readable recording medium having stored therein the data copy processing management program according to claim 12, wherein
a data copy processing capacity per unit time is calculated based on the overlap degree and the performance value, each of which is weighted by the influence degree, so as to calculate the data copy completion estimation time.

14. The non-transitory computer-readable recording medium having stored therein the data copy processing management program according to claim 13, to execute the process further comprising:
creating overlap degree transition information which indicates a transition of an overlap degree of tasks in each time zone of the plan based on the calculated data copy processing capacity per unit time.

15. The non-transitory computer-readable recording medium having stored therein the data copy processing management program according to claim 11, wherein
the overlap degree estimation information is created based on an overlap degree between a writing operation and a reading operation in the same RAID group.
